(19) United States
(12) Patent Application Publication
(10) Pub. No.: US 2026/0272232 A1
(43) Pub. Date: Sep. 17, 2026

(54) AUTONOMOUS FOOD PREPARATION SYSTEM

(71) Applicant: Otolabs Inc., Mississauga (CA)

(72) Inventors: Eeshaan Manjunaath Patil, Toronto (CA); Sayandip Roy, Mississauga (CA)

(21) Appl. No.: 19/672,198

(22) Filed: May 8, 2026

Related U.S. Application Data
(63) Continuation of application No. PCT/CA2024/051485, filed on Nov. 8, 2024.
(60) Provisional application No. 63/547,966, filed on Nov. 9, 2023.

(30) Foreign Application Priority Data
Nov. 9, 2023 (CA) 3219394

(51) Int. Cl. A47J 44/00; F24C 7/02

(52) U.S. Cl. CPC A47J 44/00; F24C 7/02

(57) ABSTRACT

The various embodiments disclosed herein relate to systems, apparatus and methods for autonomously assembling food bowls, including dispensing/adding food ingredients, and food preparation by heating. An autonomous food preparation system is provided herein. The autonomous food preparation system can comprise any one or more combinations of the following sub-assemblies: a bowl denester assembly; a paddle mechanism assembly; an autonomous dispensing assembly; and a heating assembly. The bowl denester assembly, paddle mechanism assembly, autonomous dispensing assembly, and heating assembly can be arranged above a conveyor track for a bowl to be conveyed upon, and so the food bowl can be prepared.

### CROSS-REFERENCE TO RELATED APPLICATIONS

This application is a continuation of PCT/CA2024/051485 filed on Nov. 8, 2024, and the entire contents of which are herein incorporated by reference in their entirety. This application claims the benefit of U.S. Provisional Patent Application No. 63/547,966, filed Nov. 9, 2023, and Canadian Patent Application No. 3,219,394, filed on Nov. 9, 2023, and the entire contents of U.S. Provisional Patent Application No. 63/547,966 and Canadian Patent Application No.: 3,219,394 are herein incorporated by reference in their entirety.

### TECHNICAL FIELD

The present invention generally relates to the technical field of systems for autonomously preparing food; and more specifically relates to systems and methods for autonomously dispensing food ingredients into bowls, heating the bowls, and serving the bowls.

### BACKGROUND

Quick service and fast casual restaurants typically rely on manual labour to assemble and prepare various ingredients into a meal for customers. This can result in high labour costs if a large number of workers are hired, or long wait times for customers if the restaurants are under-staffed. Having a group of staff also requires restaurants to have large footprints, resulting in higher rent and overhead costs. Furthermore, when opening a new location, there can be high setup costs, making scaling-up very expensive for restaurants.

Restaurant staff also show high levels of turn-over, resulting managers and restaurant owners being in constant hiring and training cycles. The reliance on manual labour can also expose the meals to various pathogens and other contaminants if workers do not wash their hands often. Finally, human error can pose serious risks, for example if an allergen is added to a customer's meal in error, resulting in a potentially life-threatening error. Human error can also pose a number of inconveniences, for example, if a worker mixes up orders. Furthermore, there may be inconsistencies in preparing orders between one staff member to another, as well as the same staff member day-to-day. Additionally, errors in meal preparation can also result in meals having to be re-made if customers are not satisfied with their meal, leading to increased costs.

Therefore, automated systems for food preparation can be beneficial. However, many existing automated food preparation systems rely on conveyors moving bowls from one dispenser to the next, resulting in a longer preparation time for each bowl. Furthermore, many of the existing automated food preparation systems portion ingredients using an auger-based system. However, auger-based systems can be tedious to clean due to the complexity of parts, require a large amount of maintenance, and have a high assembly and disassembly time.

### SUMMARY

The present invention relates to systems and methods for autonomously assembling or preparing food bowls by dispensing ingredients, heating the bowls, and serving the bowl to a customer.

In one aspect, an autonomous food preparation system is provided. In one embodiment, the autonomous food preparation system comprises: at least one autonomous dispensing assembly. The at least one autonomous dispensing assembly having: at least one canister containing ingredients to be dispensed; at least one attachment member coupled to each of the at least one canisters; a base platform having a dispensing aperture and at least one canister mount for each of the at least one canisters, the base platform in a fixed position; the attachment member coupling the canister to the canister mount; and at least one scoop mechanism assembly mounted on the base platform, around the outer edge of the dispensing aperture. In one embodiment, the scoop mechanism assembly comprises: a scoop-pusher slidably mounted to the base platform, the scoop-pusher removably engaging a scoop for holding a metered amount of ingredients; and the scoop having a blade edge interacting with the bottom opening of each of the at least one canisters to cut the metered amount of ingredients into the scoop. In one embodiment, the scoop mechanism assembly further comprises a blocking plate for blocking a bottom opening of the at least one scoop.

In at least one embodiment, the at least one autonomous dispensing assembly further comprises an actuator for actuating the scoop-pusher from a first position up to a second position, the second position located above the dispensing aperture.

In at least one embodiment, the scoop-pusher dispenses a metered amount of ingredients into the dispensing aperture by horizontally translating the ingredients away from the canister towards a dispensing location above the dispensing aperture.

In at least one embodiment, a bowl can be positioned under the aperture for receiving the ingredients dispensed during a dispensing period. In at least one embodiment, during the dispensing period, the scoop-pusher moves from the first position into the second position, and the relative position of the at least one canister, the bowl, and the aperture are stationary during the dispensing period.

In at least one embodiment, the autonomous food preparation system further comprises at least one channel located on the base platform for guiding a post on the scoop mechanism assembly between the first position to the second position.

In at least one embodiment, the autonomous food preparation system further comprises a conveyor coupled to the base platform to move the bowl from a first location to a second location below the dispensing aperture; the conveyor having a motor-operable driver, and a bowl guide rail to guide the bowl between the first and second locations.

In at least one embodiment, the autonomous food preparation system further comprises a canister disassembly mount detachably coupling the at least one canister to the scoop.

In at least one embodiment, the scoop-pusher and scoop move together towards the dispensing aperture when the motor is actuated to dispense the metered amount of ingredients into the aperture by horizontal translation of the ingredients away from the canister.

In at least one embodiment, the blocking plate can be placed between the scoop and the base platform to protect the ingredients in the canister from contacting the base platform.

In at least one embodiment, the canister and blocking plate are removably detached from the base platform during transportation of the canister.

In at least one embodiment, the autonomous food preparation system further comprises at least two canisters, each having a scoop mechanism assembly connected thereto. In at least one embodiment, the autonomous food preparation system optimizes the time needed to add ingredients by actuating the first scoop-pusher such that while the scoop and scoop-pusher of the first canister begins returning to the first position, a scoop and scoop-pusher of the second canister simultaneously travels up to the second position to drop the ingredients into the bowl.

In at least one embodiment, the autonomous food preparation system further comprises a stopper for stopping the bowl when the bowl reaches a position below the dispensing aperture to fill the food ingredients dispensed.

In at least one embodiment, the stopper can be actuated by a linear actuator to stop the bowl below the dispensing aperture.

In at least one embodiment, the autonomous food preparation system further comprises a Human Machine Interface (HMI) coupled to the autonomous food preparation system for placing an order; the HMI comprising a list of foods; and causing the autonomous dispensing assembly to start the dispensing period by actuating the scoop pusher to dispense the metered amount of ingredients into the bowl. In alternative embodiment, the autonomous food preparation system further comprises a camera system to scan a QR code for placing an order, and causing the autonomous dispensing assembly to start the dispensing period by actuating the scoop pusher to dispense the metered amount of ingredients into the bowl.

In at least one embodiment, the autonomous food preparation system further comprises a paddle mechanism assembly coupled to an inner chute of the at least one canister of the autonomous dispensing assembly. In at least one embodiment, the paddle mechanism assembly comprises a motor; and a food dispensing paddle. In at least one embodiment, the food dispensing paddle can be located within the canister. In at least one embodiment, the food dispensing paddle can be rotated by the motor which allows stored food in the at least one canister to be dispensed into the bowl.

In at least one embodiment, the paddle mechanism assembly can be located above the dispensing aperture.

In at least one embodiment, the paddle mechanism assembly further comprises a worm gear shaft coupled to the motor, the worm gear shaft actuating the paddle and preventing back driving of the paddle.

In at least one embodiment, wherein the motor comprises a time-controlled motor which rotates the paddle for a given amount of time, or a position-controlled motor which rotates the paddle for a number of rotations, or a given angle of rotation.

In at least one embodiment, the autonomous food preparation system further comprises a bowl denester assembly for denesting a plurality of bowls which are stacked.

In at least one embodiment, the bowl denester assembly comprises: a worm screw; a belt, a position-controlled motor; and a plurality of belt pulleys connected to the belt. In at least one embodiment, when at least one of the pulleys are actuated by the position-controlled motor, an upper ridge of the bowl from the stack of bowls makes contact with the worm screw, thereby detaching the bowl and dropping the bowl on the conveyor.

In another aspect, an autonomous food preparation system comprising a heating assembly is provided. In at least one embodiment, the heating assembly comprises a bowl heating unit having a heating source magnetron; a microwave chamber having an opening at its base; and a vertically-movable lower platform which couples to the microwave chamber by coupling to the opening at the base of the microwave chamber. In at least one embodiment, the heating assembly can be located downstream of the at least one autonomous dispensing assembly.

In at least one embodiment, the moving platform has a microwave sealing component that mates around the opening at the base of the microwave chamber and/or the moving platform. In at least one embodiment, the sealing component be the housing of the autonomous food preparation system itself.

In at least one embodiment, the microwave chamber receives the bowl by raising the vertically-movable platform from the conveyor; and once the bowl is heated, the vertically-movable platform can be lowered to a serving area.

In at least one embodiment, the bowl heating unit receives the bowl. In at least one embodiment, a bowl-pushing arm having a kinematic link and an actuator transfers the bowl from the conveyor to the heating and serving unit.

In at least one embodiment, the kinematic link retracts to allow the bowl to move to a position where it can extend to push the bowl to the food heating unit.

In at least one embodiment, the autonomous food preparation system further comprises a serving area for presenting a prepared bowl.

In yet another aspect, a method of autonomously dispensing ingredients into a bowl using an autonomous dispensing system is provided herein. In one embodiment, the method comprises: mounting at least one a scoop mechanism assembly to a base platform having a dispensing aperture of the autonomous dispensing system; coupling at least one canister to each of the scoop mechanism assemblies; providing a scoop-pusher slidably mounted to the base platform, the scoop-pusher removably engaging a scoop for holding a metered amount of ingredients; the scoop having a blade edge interacting with the bottom opening of each of the at least one canisters to cut the metered amount of ingredients into the scoop; blocking a bottom opening of the at least one scoop with a blocking plate; actuating the scoop pusher, by an actuator, to dispense a metered amount of ingredients into the aperture by horizontal translation of the ingredients away from canister location to a dispensing location above the dispensing aperture; and positioning a bowl under the aperture for receiving the ingredients dispensed. In one embodiment, a relative position of the at least one canister, the bowl, and the aperture are stationary.

In at least one embodiment, the method further comprises sliding a post on the actuator through at least one channel located on the base platform to move the scoop mechanism assembly between the first position to the second position.

In at least one embodiment, the method further comprises coupling a conveyor to the base platform to move the bowl from a first location to a second location below the dispensing aperture; the conveyor having a motor-operable driver, and a bowl guide rail to guide the bowl between the first and second locations.

In at least one embodiment, the method further comprises detachably engaging a canister disassembly mount to the at least one canister to disassemble the canister.

In at least one embodiment, the method further comprises placing the blocking plate between the scoop and the base platform to protect the ingredients in the scoop from contacting the base platform.

In at least one embodiment, the canister and blocking plate are removably detached from the base platform during transportation of the canister.

In at least one embodiment, the autonomous dispensing system can comprise at least two canisters, each having a scoop mechanism assembly connected thereto. In at least one embodiment, the method further comprises optimizing the time needed to add ingredients by actuating the first scoop-pusher such that while the scoop and scoop-pusher of the first canister begins returning to the first position, a scoop and scoop-pusher of the second canister simultaneously travels up to the second position to drop the ingredients into the bowl.

In at least one embodiment, the method further comprises stopping the bowl, via a stopper, when the bowl reaches a position below the dispensing aperture to fill the food ingredients dispensed.

In at least one embodiment, the method further comprises actuating the stopper by a linear actuator to stop the bowl below the dispensing aperture.

In at least one embodiment, the method further comprises coupling a Human Machine Interface (HMI) to the food preparation system for placing an order; the HMI comprising a list of foods; and causing the autonomous dispensing assembly to start the dispensing period by actuating the scoop pusher to dispense the metered amount of ingredients into the bowl.

In at least one embodiment, the method further comprises: coupling a paddle mechanism assembly to an inner chute of the at least one canister of the autonomous dispensing assembly.

In at least one embodiment, the paddle mechanism assembly can comprise: a motor; and a food dispensing paddle; wherein the food dispensing paddle is located within the canister. In at least one embodiment, the method further comprises rotating the food dispensing paddle by the motor which allows stored food in the at least one canister to be dispensed into the bowl.

In at least one embodiment, the paddle mechanism assembly is located above the dispensing aperture.

In at least one embodiment, the paddle mechanism assembly further comprises a worm gear shaft coupled to the motor, and the method further comprises actuating the worm gear shaft and the paddle to prevent back driving of the paddle.

In at least one embodiment, the method further comprises actuating a time-controlled motor to rotate the paddle for a given amount of time, or actuating a position-controlled motor to rotate the paddle for a number of rotations, or a given angle of rotation.

In at least one embodiment, the method further comprises denesting the bowl from a stack of bowls using a bowl denester assembly.

In at least one embodiment, the bowl denester assembly can comprise: a worm screw; a timing belt, a position-controlled motor; and a plurality of belt pulleys connected to the belt. In at least one embodiment, when at least one of the pulleys is actuated by the position-controlled motor, an upper ridge of the bowl from the stack of bowls makes contact with the worm screw, thereby detaching the bowl and dropping it on the conveyor.

In at least one embodiment, the method further comprises heating the bowl via a heating assembly. In at least one embodiment, the heating assembly can comprise: a bowl heating unit having a heating source magnetron; a microwave chamber having an opening at its base; and a vertically-movable lower platform which couples to the microwave chamber by coupling to the opening at the base of the microwave chamber.

In at least one embodiment, the moving platform has a microwave sealing component that mates around the opening at the base of the microwave chamber and/or the moving platform.

In at least one embodiment, the microwave chamber receives the bowl by raising the vertically-movable platform from the conveyor; and once the bowl is heated, the vertically-movable platform is lowered to a serving area.

In at least one embodiment, the bowl heating unit receives the bowl; and wherein a bowl-pushing arm having a kinematic link and an actuator transfers the bowl from the conveyor to the heating and serving unit.

In at least one embodiment, the kinematic link retracts to allow the bowl to move to a position where it can extend to push the bowl to the food heating unit.

In at least one embodiment, the method further comprises presenting a prepared bowl at a serving area.

In another aspect, a method of optimizing the dispensing of food ingredients in a plurality of canisters using an autonomous dispensing assembly is provided herein. In at least one embodiment, the method comprises: determining two or more of the plurality of canisters to be actuated simultaneously; and parallelizing serving by actuating the determined at least two of the plurality of canisters to dispense ingredients.

In at least one embodiment, determining two of more of the plurality of canisters comprises: inputting an order; marking a number of canisters that correspond to the order as active canisters; representing the active canisters as a plurality of nodes; constructing a graph from the plurality of nodes, and ignoring adjacent nodes from the graph; and determining, by maximum matching, pairs of edges where none of the plurality of nodes are shared.

In at least one embodiment, the method further comprises: assigning weights to the pairs of edges to prioritize specific pairs of edges corresponding to prioritized canisters.

In at least one embodiment, the method further comprises: ranking the assigned weighting based on at least one of the following factors: sequence of serving, time constraints, or customer preferences.

In at least one embodiment, parallelizing serving by actuating the determined at least two of the plurality of canisters to dispense ingredients further comprises: actuating at least two scoop mechanism assemblies connected to the at least two canisters, such that while a scoop and scoop-pusher of the first canister begins returning to a first position, a scoop and scoop-pusher of the second canister simultaneously travels up to a second position to dispense the ingredients.

### BRIEF DESCRIPTION OF THE DRAWINGS

FIG. 1A illustrates a front view of an autonomous serving system according to one embodiment.

FIG. 1B illustrates a top view of the autonomous serving system according to one embodiment.

FIG. 2 illustrates a food bowl being at a stopped condition according to one embodiment.

FIG. 3 illustrates a bowl denester assembly according to one embodiment.

FIG. 4A illustrates the internal mechanism of the bowl denester assembly according to one embodiment.

FIG. 4B illustrates the internal mechanism of the bowl denester assembly according to one embodiment.

FIG. 5A illustrates a perspective view of the scoop mechanism assembly according to one embodiment.

FIG. 5B illustrates a top perspective exploded view of the scoop mechanism assembly according to one embodiment.

FIG. 5C illustrates an exploded view of the scoop mechanism assembly according to one embodiment.

FIG. 5D illustrates an isolated view of the scoop mechanism assembly coupled to the actuator assembly according to one embodiment.

FIG. 5E illustrates a perspective view of the canister disassembly mount according to one embodiment.

FIG. 6A illustrates a side perspective view of the scoop mechanism connected to the autonomous dispensing assembly according to one embodiment.

FIG. 6B illustrates a top view with a broken-out section view of the scoop mechanism connected to the autonomous dispensing assembly according to one embodiment.

FIG. 7 illustrates a side view along with a cross-section view of FIG. 1A.

FIG. 8 illustrates a top view of a pair of scoops opposite to one another in the autonomous dispensing assembly according to one embodiment.

FIG. 9 illustrates a scoop mechanism being removed from the autonomous dispensing assembly after use according to one embodiment.

FIG. 10A illustrates a paddle mechanism assembly, according to one embodiment.

FIG. 10B illustrates the paddle mechanism assembly, according to one embodiment.

FIG. 11A illustrates a left perspective view of the paddle mechanism assembly in a detached position according to one embodiment.

FIG. 11B illustrates a front perspective view of the paddle mechanism assembly in a detached position according to one embodiment.

FIG. 12A illustrates a kinematic link in an extended position which allows the bowl to pass underneath it before it can push it according to one embodiment.

FIG. 12B illustrates the kinematic link in a retracted position to transfer the food bowl from the conveyor according to one embodiment.

FIG. 13 illustrates the kinematic link in a retracted position which allows the bowl to pass underneath it before it can push it according to one embodiment.

FIG. 14 illustrates the kinematic link in an extended position to transfer the food bowl from the conveyor according to one embodiment.

FIG. 15A illustrates the moving platform of the heating unit according to one embodiment.

FIG. 15B illustrates the moving platform of the heating unit according to one embodiment.

FIG. 16 illustrates a serving door of the autonomous food preparation system apparatus according to one embodiment.

FIG. 17 illustrates a side view of the autonomous food preparation system apparatus according to one embodiment.

FIG. 18 illustrates a top view of autonomous dispensing assembly according to one embodiment depicting parallel serving/dispensing of ingredients in two canisters in progress.

FIG. 19 provides a process flow diagram of the collision avoidance method.

FIG. 20A-D provides a schematic diagram showing various graphs constructed for the collision avoidance method.

FIG. 21 provides a schematic diagram showing a network of autonomous food preparation systems.

### DETAILED DESCRIPTION OF EMBODIMENTS

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

It should also be noted that the terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, an electrical signal, a light signal or a mechanical element depending on the particular context.

It should also be noted that, as used herein, the wording “and/or” is intended to represent an inclusive-or. That is, “X and/or Y” is intended to mean X or Y or both X and Y, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

Similarly, throughout this specification and the appended claims the term “communicative” as in “communicative pathway”, “communicative coupling”, and in variants such as “communicatively coupled” is generally used to refer to any engineered arrangement for transferring and/or exchanging information. Examples of communicative pathways include, but are not limited to, electrically conductive pathways (e.g., electrically conductive wires, physiological signal conduction), electromagnetically radiative pathways (e.g., radio waves, optical signals, etc.), or any combination thereof. Examples of communicative couplings include, but are not limited to, electrical couplings, magnetic couplings, radio couplings, optical couplings or any combination thereof.

A portion of the example embodiments of the systems, devices, or methods described in accordance with the teachings herein may be implemented as a combination of hardware or software. For example, a portion of the embodiments described herein may be implemented, at least in part, by using one or more computer programs, executing on one or more programmable devices comprising at least one processing element, and at least one data storage element (including volatile and/or non-volatile memory). These devices may also have at least one input device (e.g., a keyboard, a mouse, a touchscreen, an input pin, an input port and the like for providing at least one input such as an input signal, for example) and at least one output device (e.g., a display screen, a printer, a wireless radio, an output port, an output pin and the like for providing at least one output such as an output signal, for example) depending on the nature of the device.

It should also be noted that there may be some elements that are used to implement at least part of the embodiments described herein that may be implemented via software that is written in a high-level procedural language such as object-oriented programming. The program code may be written in C, C++ or any other suitable programming language and may comprise modules or classes, as is known to those skilled in object-oriented programming. Alternatively, or in addition thereto, some of these elements implemented via software may be written in assembly language, machine language, or firmware as needed.

At least some of the software programs used to implement at least one of the embodiments described herein may be stored on a storage media or a device that is readable by a general or special purpose programmable device. The software program code, when read by the programmable device, which may also be referred to as a computing device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, memory chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

Any module, unit, component, server, computer, terminal or computing device described herein that executes software instructions in accordance with the teachings herein may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto.

The various embodiments disclosed herein relate to systems, and methods for autonomously assembling food bowls, including dispensing/adding food ingredients, and food preparation by heating. In particular, the various embodiments disclosed herein relate to an autonomous food preparation system apparatus.

Preparation refers to the assembly of food ingredients into a meal for consumption. For example, the meals that can be prepared include: rice bowls, pasta bowls, salads, noodles, curries, and the like. In some embodiments, the preparation of food need not involve cooking the food. In some embodiments, the preparation of food can include heating the ingredients.

Ingredients refer to the raw or semi-prepared food materials disposed of in the canisters. Sample ingredients include: chopped fruits and vegetables, grains, lentils, pulses, leafy vegetables, starches, rices, pastas, noodles, curries, slurries, processed foods, etc.

Dispensing refers to the dropping of ingredients into a container or other holding apparatus. The term ‘bowl’ is used to refer to any container or apparatus for holding the ingredients to be dispensed, and can include other plates, serving apparatus, cups, trays, parchment or wax papers, disposable or single use containers, etc. In some embodiments, the containers may also be food ingredients such as, breads, flatbreads, edible bowls, etc.

The autonomous food preparation system described herein can comprise any one or more combinations of the following sub-assemblies: a bowl denester assembly; a paddle mechanism assembly; an autonomous dispensing assembly; and a heating assembly. The autonomous food preparation system can also include a conveyor assembly. The bowl denester assembly, paddle mechanism assembly, autonomous dispensing assembly, and heating assembly can be arranged above the conveyor assembly for a bowl to be conveyed upon.

In one embodiment, the food preparation system can receive an input from a Human Machine Interface (HMI) for placing an order. The HMI can consist of a list of foods/processed foods in an electronic form displayed to the user to select a food or food mixture as input to the interactive machine through which the user places an electronic order for food. The HMI can be interfaced with a controller, which controls the autonomous dispensing assembly as per the placed electronic order. In an embodiment, users can also place orders from their mobile app and scan a QR code or NFC which relays and places the order to the food preparation system. In another aspect, the food preparation system may also interface with third-party enterprises (such as delivery apps) to allow users to place orders through such enterprises so that the food preparation system can prepare orders in advance or allow delivery personnel to scan a code and prepare the order.

In one embodiment, when an order is received, the bowl denester assembly detaches, denests, or separates one food bowl from a stack of bowls. The food bowl can be dropped onto the conveyor assembly. The conveyor assembly can include a conveyor belt for transporting the bowl to the various sub-assemblies, or ‘stations’. Each location where food is dispensed into the food bowl-whether it be from a paddle mechanism assembly, autonomous dispensing assembly, a stand-alone scoop mechanism assembly, or a heating assembly can be considered a ‘station’. In an alternative embodiment, a bowl can be provided by placement on the conveyor belt, such as by manual placement. In an alternative embodiment, a bowl can be placed under a station. Once the bowl is on the conveyor, the bowl can be stopped at various stations to be filled, heated, or otherwise be prepared. In some embodiments, multiple bowls can be prepared simultaneously. For example, a first bowl may be denested from the stack of bowls and conveyed to the first station, whilst a second bowl is being simultaneously conveyed to a second station for filing. In some embodiments, the second bowl can wait at a holding zone on the conveyor until the station is clear while a third bowl is being heated, etc.

Once the food bowl reaches a station such as an autonomous dispensing assembly, or paddle mechanism assembly, it can be filled with ingredients. The paddle mechanism assembly or autonomous dispensing assembly can house a variety of ingredients, which includes but is not limited to, granular ingredients; soft and/or soaked ingredients; garnishes and shredded/finely chopped vegetables.

In one embodiment, if the ingredients are dispensed in a paddle mechanism assembly, the ingredients become separated into sections between the vanes of the paddle. The rotation of the paddle allows metered dispensing of the contained ingredients into the food bowl underneath it.

In one embodiment, if the ingredients are dispensed in an autonomous dispensing assembly, the ingredients are contained within canisters. Each canister can have a scoop mechanism assembly attached thereto. The scoop can be linearly slide-able and is coupled with a pusher that pushes the scoop forward such that the ingredients contained in the scoop drop into the food bowl.

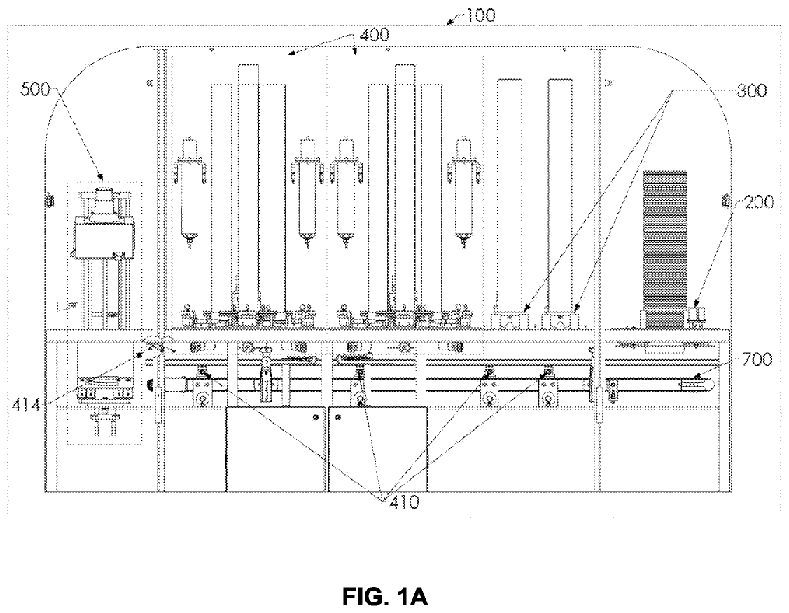

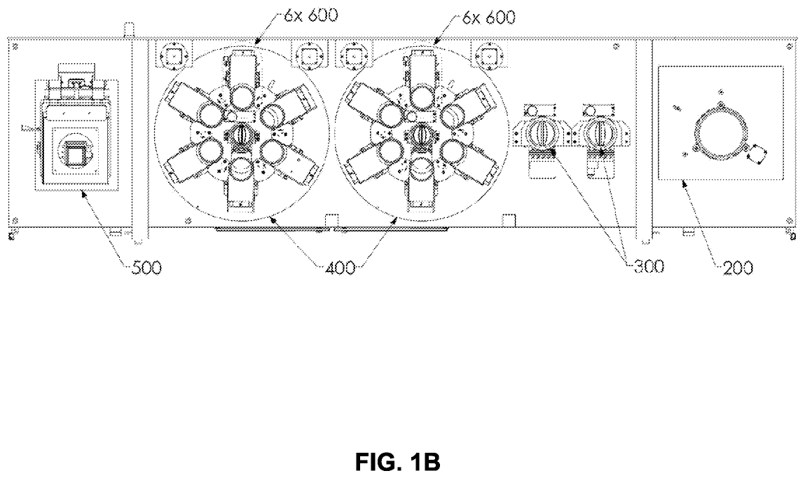

Turning now to the figures, FIG. 1A provides a front-view of an autonomous food preparation system 100, according to at least one embodiment. The system 100 can comprise at least one of the following sub-assemblies: at least one bowl denester assembly 200; at least one paddle mechanism assembly 300; at least one autonomous dispensing assembly 400; and a heating assembly 500. In one embodiment, the sub-assemblies can be arranged within, or proximal to the autonomous food preparation system 100. The system 100 can include any one or more of the sub-assemblies in any order or combination. For example, and as shown in FIG. 1B, a first bowl denester assembly 200, two paddle mechanism assemblies 300, two autonomous dispensing assemblies 400, and one heating assembly 500 are provided. Any other suitable configuration of the sub-assemblies is also possible. It can be understood that each assembly may be increased to n number in any combination. In an embodiment, a combination of paddle mechanism assemblies, bowl denesting assemblies, and autonomous dispensing assemblies can be provided. In another embodiment, a pair of autonomous dispensing assemblies instead of the paddle mechanism assemblies can be provided.

The autonomous dispensing assembly 400 can have a plurality of scoop mechanisms 600. In the embodiment shown in FIG. 1B, the plurality of scoop mechanisms 600 are placed in a circular arrangement. In yet another embodiment, the circular autonomous dispensing layout assembly 400 shown in FIG. 1B, may be modified to be a linear layout assembly. The autonomous dispensing assembly allows the food bowl as well as the stored ingredients to remain stationary, yet dispense multiple ingredients within a short amount of time which is achieved by parallelizing the actuation of each scoop mechanism assembly. The parallel serving method improves time efficiency of the food preparation system by allowing one or many scoops to simultaneously be driven forward to dispense the next ingredient, while the previous scoop(s) returns after dispensing an ingredient. This can dramatically reduce the time required for dispensing multiple ingredients. Similarly, all the ingredients from several canisters can be added to the bowl.

In one embodiment, the autonomous dispensing assembly can also include at least one sauce dispenser. The sauce dispenser can have tubing that is routed in between the canisters and/or other mechanical components to pour liquid or sauces through a nozzle and into the bowl.

After dispensing the food ingredients, the conveyor can move the bowl to the food heating unit, where the food bowl is heated before serving. In one aspect, the food heating unit is an automated microwave heating unit. The autonomous food preparation system can further include a serving area or unit for presenting the bowl to a customer or worker when prepared. In an alternative embodiment, the food bowl does not need to be heated, but can be served once the ingredients are dispensed and bowl is prepared. This can be advantageous for cold food items such as salads, deserts, smoothie bowls, etc. Once the bowl is prepared, the user can obtain the bowl from the serving unit.

### Conveyor Assembly

The conveyor assembly 700 can be used to connect or link the various assemblies. The conveyor assembly can include a conveyor 700 that is placed below, or adjacent to the assemblies. The conveyor can connect one assembly to the next sequentially. For example, the conveyor can be placed below the paddle mechanism assembly 300 and/or scoop mechanism assembly 600. This allows the bowl to travel from one assembly to the next. The sub-assemblies can also be sequenced in a suitable order. For example, the paddle mechanism assembly 300 can be connected in sequence to the bowl denester assembly 200, etc.

In one embodiment, when a food order is received by the autonomous food preparation system 100, the preparation of the food bowl can begin. The bowl can reach the autonomous dispensing assembly 400 as it travels on the conveyor 700. In an embodiment, the conveyor 700 is operable by a drive mechanism that starts and stops running each time a bowl reaches a station. In another embodiment, the bowl is stopped at the station by using bowl stoppers 410 along the conveyor or using any number of sections of conveyors to transport the bowl from station to station, while the conveyor is continuously running. Accordingly, the operating conveyor time, speed of the conveyor, and food bowl traveling period may be changed.

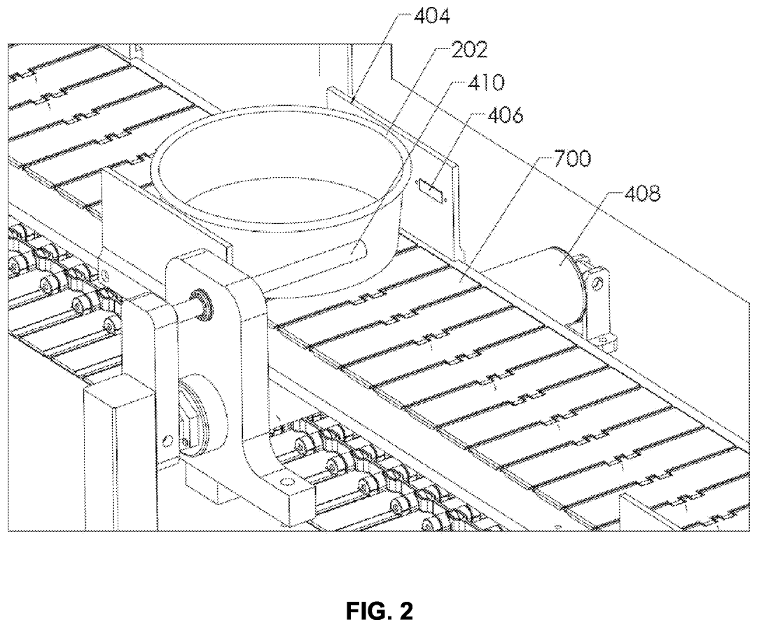

Referring to FIG. 2, in the autonomous dispensing assembly 400 the food bowl 202 on the conveyor 700 reaches a position where a stopper 410, located underneath a station obstructs the travel path and stops the food bowl 202, for the dispenser at the station to dispense food ingredients into it. The stopper 410 is actuated by a linear actuator 408. A bowl guide rail 404 prevents the food bowl 202 from shifting off the travel path of the conveyor 700 and centers it to prevent spillage. A trip sensor 406 can be positioned to detect the presence of a bowl 202 before the first scoop dispensing assembly 600 dispenses relevant ingredients into the bowl 202. In an embodiment, stoppers 410, their respective actuators 408, and a trip sensor 406 are located under each station along the conveyor 700. Particularly, the stopper 410 is in a closed state where it stops the food bowl 202 to fill food ingredients. If ingredients from a given station are not part of the order, the stopper 410 is in an open state, and the food bowl 202 can be carried by the conveyor 700 to the next station.

The bowl 202 butts up against a stopper 410 that stops the bowl at the paddle mechanism assembly 300. Once the controller receives feedback that the paddle mechanism assembly 300 has dispensed the instructed portion of ingredients into the bowl 202, and the next station does not have a bowl present and so is ready to receive a new bowl, the stopper 410 opens to release the bowl 202 and allow the conveyor 700 to carry the bowl to the next station. A station is considered ‘ready’ when the dispenser in the station is not dispensing, the respective stopper 410 is in a closed state, and the trip sensor 406 in that station does not detect the presence of a bowl 202 or debris or any other kind of obstruction. After receiving the food, the bowl moves on the conveyor 700 to the next station, for example the paddle mechanism assembly 300 or the autonomous dispensing assembly 400.

In one embodiment, the conveyor 700 carries the bowl 202 to the first station where it is stopped by the first stopper 410 such that the bowl is centered below the first paddle mechanism 300 or autonomous dispensing assembly 400 or scoop mechanism assembly 600. The trip sensors 406 located under each station are used to detect the presence of a bowl 202 when it arrives at its respective dispenser. The trip sensor 406 also communicates to the controller if a subsequent dispenser has an obstruction or is busy which prevents a preceding stopper 410 from releasing its food bowl 202 to avoid bowl collisions. The stopper 410 can be operated to stop the food bowl 202. If the next station/dispenser is free and once the first station is done serving, the first stopper 410 opens, allowing the bowl to progress to the next station. The food bowl 202 is then carried forward by the conveyor 700 to the next station until it is stopped by the second station/dispenser's stopper 410 such that the bowl is centered below the second station. Said process goes on for n number of dispenser assemblies (300, 400, or 600). If the moving platform 512 is free (does not detect a bowl 202 with it) and is positioned at the conveyor level (lowest level), and the last (or nth) station is done serving, the last (or nth) stopper 410 opens, allowing the bowl to progress toward the moving platform 512.

### Bowl Denester Assembly

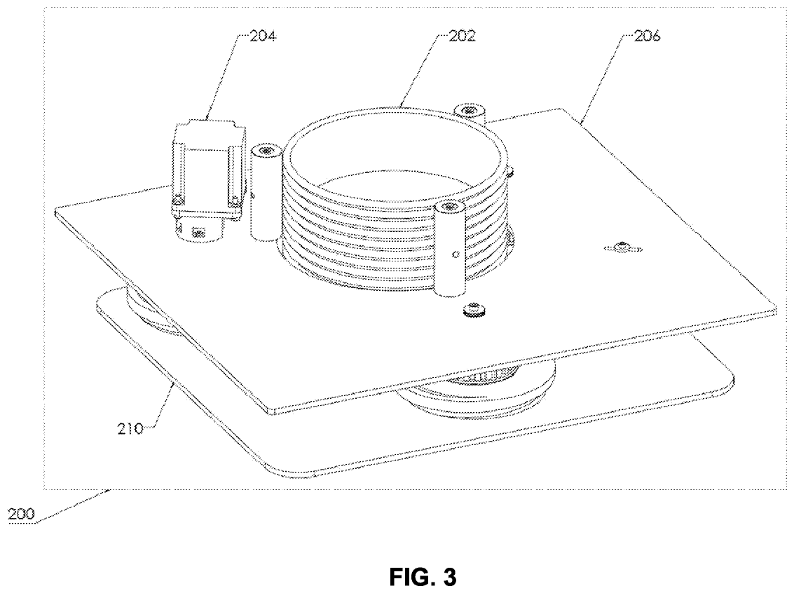

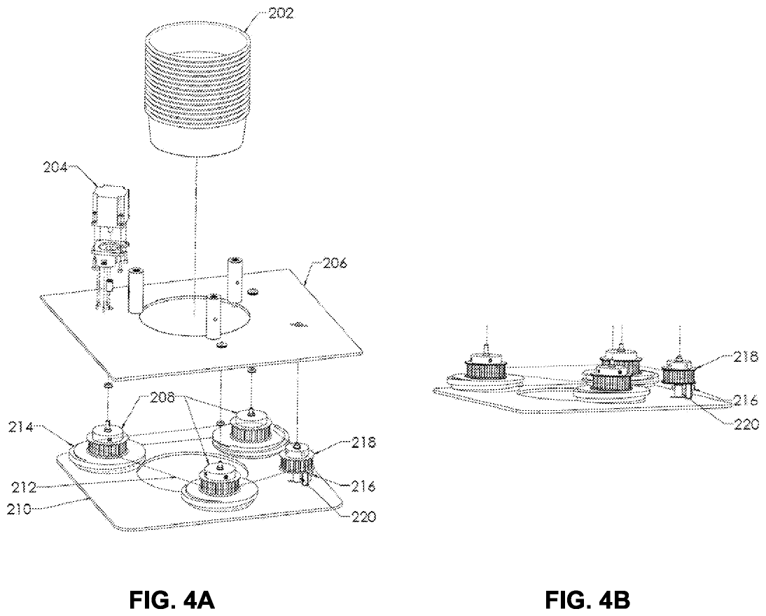

Referring to FIGS. 3, 4A and 4B, the bowl denester assembly 200 is provided. In at least one embodiment, the bowl denester assembly 200 unstacks, or de-nests one bowl from a stack of bowls. The bowl denester assembly 200 can include a denester motor 204; a top plate 206; a plurality of belt pulleys 208, a bottom plate 210, and a belt or a chain 212. In at least one embodiment, three belt pulleys 208 are placed between the top plate 206 and bottom plate 210. The top and bottom plates can include a central bowl-holder in which a stack of bowls 202 are placed. One of the three belt pulleys can be a driving pulley, and the remaining two belt pulleys can be driven pulleys. Each belt pulley 208 can be connected to a worm screw 214 via pulley shafts. The three belt pulleys 208 can be connected to one another by the belt or chain 212. The belt or chain 212 can be tensioned by adjusting a tensioning bolt 216 which pulls a shaft 220 carrying a tensioning pulley 218 and tensions the belt 212. In one embodiment, the new bottom bowl (i.e. n+1 bowl) make contact with the top flight of the worm screw as the leading edge wedges between the bottom most bowl and the one above it. As the pulleys are actuated by the denester motor 204, the bottom bowl 202 becomes separated as it is fed through flights of the worm screw 214 thereby detaching the bowl 202 from the stack of bowls and dropping it onto the conveyor 700. In at least one embodiment, the bowl 202 sits on the top flat face of the worm screw. When the pulleys actuate, the worm screw can rotate and the leading edge of the worm screw flight slides between the bottom bowl and the adjacent bowls in the stack and separates them by increasing distance between them. The timing belt can keep the worm screws synchronized to avoid misalignment between the worm screw and the edge of the bowls. It can be possible to utilize two worm screws, but three worm screws can provide a platform for the bowl to rest on, and is ideal. The speed of the worm screws can be adjusted so the bowls are denested faster or slower. In an alternative embodiment, the bowl denesting assembly can denest a bowl using suction.

### Autonomous Dispensing Assembly and Scoop Mechanism Assembly

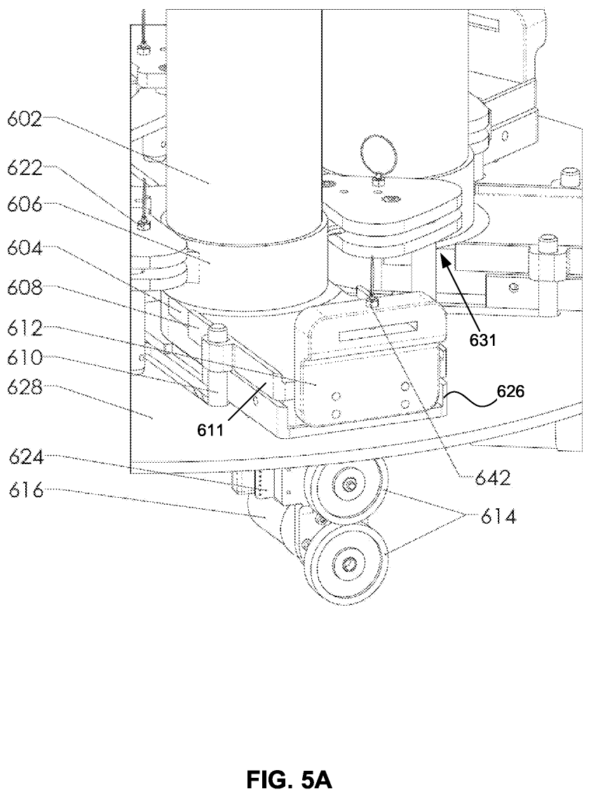

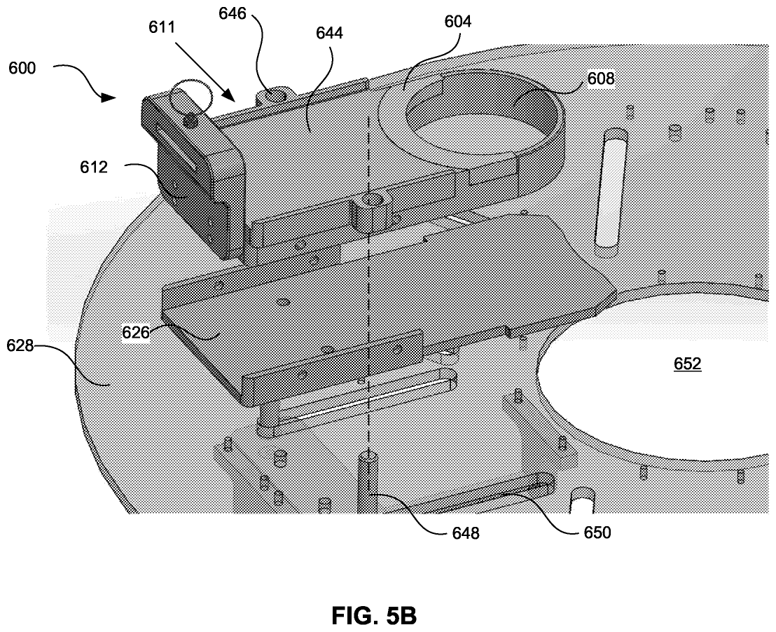

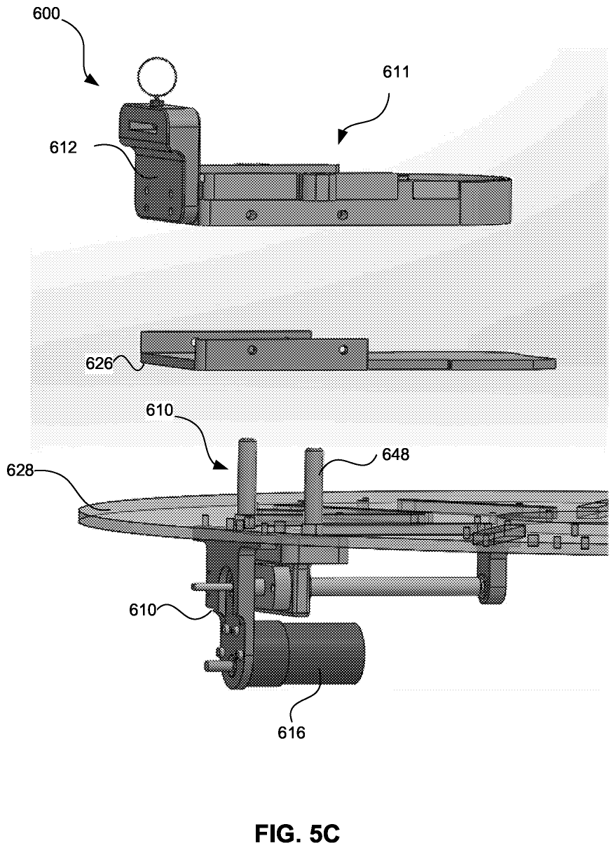

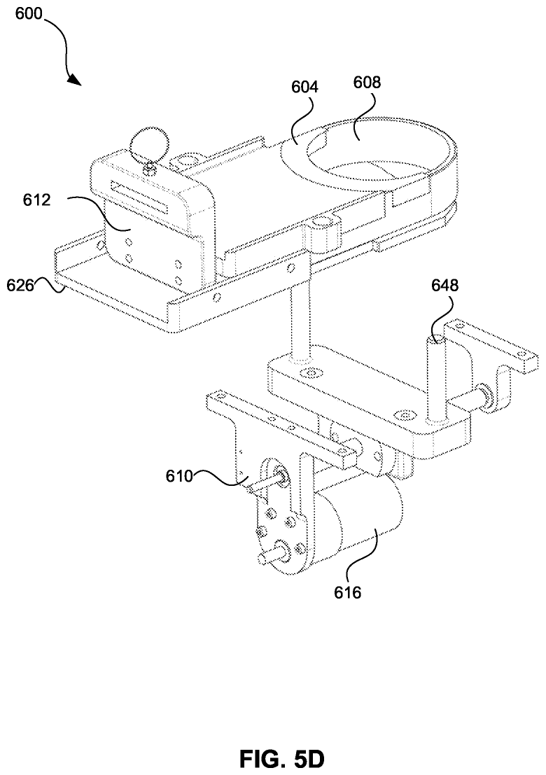

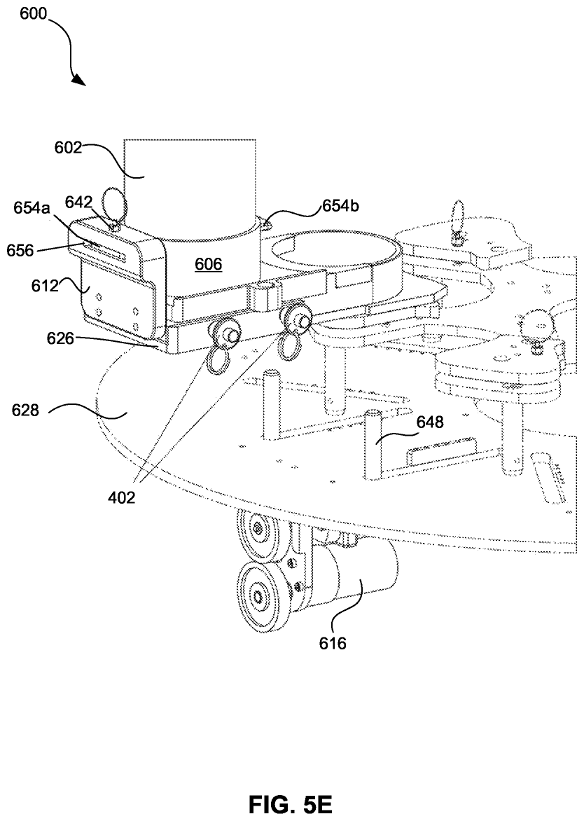

Referring now to FIGS. 5A-5E, a close-up view of an autonomous dispensing assembly is provided. FIG. 5A provides a detailed view of the scoop mechanism assembly 600. In one embodiment, the scoop mechanism assembly 600 includes the scoop 608; scoop main-body 611, the blade edge 604, and blocking plate 626. The scoop mechanism assembly 600 can be actuated by the scoop-pusher 610. The autonomous dispensing assembly can also include an actuator or motor 616, and transmission gears 614 which couple to the scoop main-body 611, and actuates the scoop and/or the blade edge 604. In one embodiment, the scoop mechanism assembly can also include a canister disassembly mount 612; and a spring-loaded pull pin 622 to mount the canister to the scoop main-body during transportation or stowing configurations. A distance sensor 624 can also be provided to measure the distance to the scoop-pusher 610. An encoder can also be included to measure a distance or rotation of the actuator 616. In one embodiment, the distance sensor 624 can provide redundancy to the encoder. In some embodiments, the encoder can be optional, and can be replaced with a timed dispensing mechanism. The encoder can check if the motor shaft is turning. The distance sensor can be used to determine if the scoop is appropriately moving forward and backward, ensuring that the ingredients were dispensed. In at least one embodiment, the distance sensor can include, but is not limited to, any one or more of the following sensors: time of flight sensors, lidar sensors, radar sensors, ultrasonic sensors, electromagnetic transducers, etc.

The autonomous dispensing assembly 600 can include at least one canister 602 containing ingredients to be dispensed, a base platform 628, and at least one scoop mechanism assembly 600 mounted on the base platform 628. The at least one canisters can be coupled to the at least one scoop mechanism assembly. In one embodiment, the scoop 608 is placed below the canister 602, such that the blade edge of the scoop interacts with the bottom opening of the canister. In an embodiment, the canister 602 can be of any varying or fixed cross-sectional shape.

The canister 602 can also optionally include, or be coupled to a canister sleeve 606. The canister sleeve 606 can have an opening for holding each of the canisters in an upright position, and to allow the canister 602 to be statically mounted or fixed to the scoop mechanism. The canister sleeve 606 can be coupled with the canister 602. In an embodiment, the canister sleeve 606 and canister 602 could be optionally provided as a singular component. For example, the canister sleeve could be made as part of the canister 602 using injection molding, or any other suitable fabrication method. The canister or the canister sleeve can have flanges or winged attachment members 654a or 654b that are sized to fit into a slot 656 of the canister disassembly mount in the stow/transport configuration; or in the canister mount 631 in the dispensing configuration. The canister sleeves 606 can also be designed such that the canister can be securely mounted to and easily detached from the scoop 608, allowing for easy disassembly for cleaning.

The blocking plate 626 is provided to block the bottom opening of the scoop during the times that the scoop is not dispensing. In one embodiment, the blocking plate blocks the bottom opening of the scoop when the scoop is in the first position, namely in the rest position. When the scoop is in the dispensing positions, the blocking plate does not block the bottom opening of the scoop, such that the ingredients in the scoop can fall out of the scoop (via gravity) and into a dispensing aperture. The blocking plate 626 can also be referred to as a scoop tray 626.

The dispensing aperture 652 is provided on the base platform 628. In one embodiment, the dispensing aperture 652 can be centrally located on the base platform. In an alternative embodiment, the dispensing aperture can be offset. The dispensing aperture can also be sufficiently large enough such that the plurality of scoop mechanism assemblies can be arranged around it, and have access to the dispensing aperture when the scoop is in the dispensing position.

While disassembling the canister for stowing, restocking, cleaning or maintenance, the canister can be coupled to the canister disassembly mount 612. In an embodiment, the canister disassembly mount 612 is provided on the scoop mechanism assembly. The canister disassembly mount can use a spring-loaded pull pin 642 to couple the canister 602 to the top face of the scoop main body 611. The disassembly of the canister and scoop mechanism assembly is accomplished by sliding the canister 602 or canister sleeve 606 on the top face 644 of the scoop 608 and sliding the flange 654a of canister 602 or canister sleeve 606 into the slot 656 of the canister disassembly 612. In an embodiment, the flange 654b can be engaged with the spring-loaded pull pin 642, to prevent the canister 602 from moving around during transport. When disassembling the canister, the flat-top face of the scoop mechanism assembly acts as a lid, preventing food in the canister from falling out during transport. In an embodiment, the scoop tray 626 can be coupled with the scoop mechanism assembly during transport to avoid food spillage despite the scoop holding un-dispensed ingredients. As such, the blocking plate 626 can remain under the scoop if there are ingredients present in the scoop. If there are no ingredients in the scoop, the canister and scoop assembly can be transferred without the blocking plate.

FIG. 5B provides an exploded view of the scoop mechanism assembly 600. In one embodiment, the scoop main body 611 has a flat-topped back 644 on one end, and a scoop 608 located on another end. The head portion of the scoop main body 611 can have a containment section to cup the ingredients in the canister. The back 644 of the scoop can be flat-topped to act as a blocker for the ingredients within the canister 602 that is above the scoop 608. It also allows the scoop to act as a bottom lid for a full canister in the “stow/transportation” configuration. This allows the scoop mechanism assembly to be easily engaged/disengaged for cleaning. On either side of the scoop main body 611, flanges 646 parallel to the base platform 628 protrude out from the scoop body. The flanges can also be perpendicular and along the direction of travel of the scoop. The flanges 646 guide the sleeve as between the “stow” and “engage” configurations of the canister.

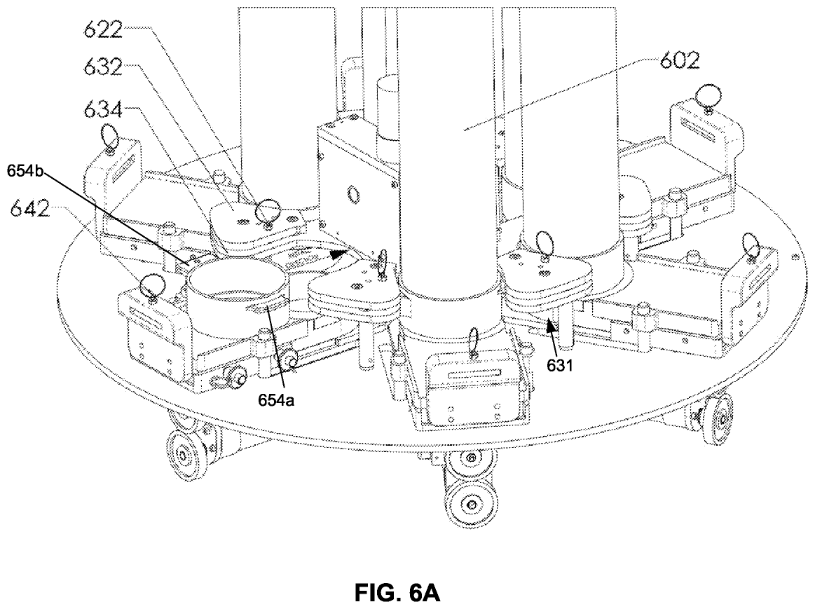

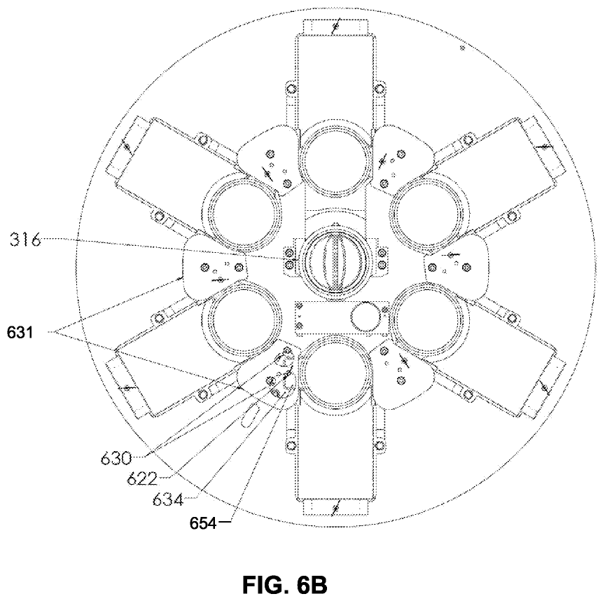

Turning now to FIGS. 6A and 6B, which illustrate details of the scoop mechanism assembly when connected to the autonomous dispensing assembly 400. Once the canister is ready to be placed into the dispense position, the flange 654b can be placed into the canister mount 631. The canister mount 631 is connected to the base platform. One canister mount 631 can be used to mount one canister 602. In an alternative embodiment, one canister mount 631 can be shared between two adjacent canisters. In one embodiment, the canister mount can include a canister mount top plate 632 and a canister mount bottom plate 634. A spacer ring 630 is sandwiched between the canister mount top plate 632 and the canister mount bottom plate 634 to create a gap to allow the flange portion 654b of the canister sleeve 606 to slide in between the canister mount top plate 632 and canister mount bottom plate 634. The spring-loaded pull pin 622 can be fixed to the canister mount top plate 632 thereby allowing the canister sleeve 606 and therefore the canister 602 to be securely mounted and easily detachable. The canister disassembly mount 612 and the canister mount 631 mechanisms allow the canister to be easily and quickly coupled and decoupled from the autonomous dispensing assembly 400.

In one embodiment, the canister mount 631 can be modified to allow the install direction of the canister 602 to be normal to the circular base platform 628 by including features that allow the flange of the canister sleeve 606 to be rotated to lock it into the autonomous dispensing assembly 400 or be clamping features or be snap-fit. This may have the advantage of reducing the time needed to replace canisters and reduce the chances of spillage. The canister mount 631 can also be provided in other mounted methods which allow the canister to be removably mounted to the base platform in any suitable way.

When the canister is mounted correctly, the dispensing of ingredients can begin. The scoop 608 detachably couples with the scoop-pusher 610 via posts 648 that couple to the flanges 646 of the scoop body. The posts 648 can then slide within slots 650 formed in the base platform (shown in FIG. 5B). The scoop moves from a first position to a second position. The first position refers to the position where the scoop hole is aligned with canister opening at the bottom, or proximal to the outer edge of the base platform 628. The second position refers to the position that is towards the dispensing aperture 652 and away from the canister 602, thereby thrusting the blade 604 to slice through the entire diameter of the canister and horizontally translating the ingredients away from the canister to a dispensing location at the dispensing aperture 652. In an embodiment, knife 604 is directly with the scoop 608. This allows the scoop to slide forward and dispense ingredients without any spillage. In some embodiments, the scoop mechanism assembly can be placed on the base platform 628 such that the scoop, in the second position, is above the dispensing aperture. In some embodiments, the scoop can actuate only a portion of the way forward. For example, the scoop can push fully forward, halfway forward, one quarter of the way forward, or any other phase or percentage. This allows for the fractional dispensing of ingredients, for example, if only half a portion is needed, the scoop can move forward only halfway, as opposed to the full way. The distance sensor 624 indicates the displacement of the scoop 608.

In one embodiment, the scoop-pusher 610 removably couples with a scoop 608 for holding a metered amount of ingredients received from the canister 602. The scoop 608 further couples with a sharp knife or blade edge 604. The knife or blade edge can be replaced over time as the sharp edge wears out. When the scoop-pusher 610 is actuated, the sharp knife or blade edge 604 first intersects the ingredients located in the canister 602 to slice and accurately separate and/or slice a portion of the ingredients. The size of the scoop can determine the portion size, for example, a larger scoop will portion more ingredients. The blade 604 is interacting with the bottom opening of each of the canisters 602 to portion a metered amount of ingredients into the scoop 608. The scoop slices and moves the separated ingredients forward. The scoop-pusher moves from a first position to a second position, thereby actuating the blade 604 to slice through the entire diameter of the bottom opening and providing horizontal translation of the ingredients away from the canister to a dispensing location. The scoop mechanism assembly 600 also includes a linear actuator for actuating the scoop-pusher. The linear actuator can be a pneumatic cylinder/piston, lead-screw, slider-cam, scotch-yoke, or another type of actuator that can actuate the scoop-pusher to move forward and backward, or sideways.

Each canister can also be uniquely identified with a tag or marker, such as by using RFID or a barcode system. This provides a feedback loop to ensure that the correct canister is loaded into the appropriate canister sleeve, allowing the processor to determine which ingredients are located in which canister. This also allows for duplication of canisters to reduce serving time, determine dispensing order, and prioritization of certain canisters to follow a first-in-first-out (FIFO) dispensing order. For example, if one canister has “older” ingredients and another duplicated canister has “newer” ingredients, the system can ensure that the older ingredients have prioritized dispensing. In an alternative embodiment, each canister and scoop assembly can include a pair of mechanical fittings, the first being a protruding male side and the second being a mating female side to ensure that the correct canister is paired with the appropriate scoop assembly. In one embodiment, the flange 655 could be included on each of the canisters at varying heights, and the canister mount can be placed at the appropriate height to allow the right canister to be installed into the right location, and prevent installing the wrong canister in the wrong location. In an alternative embodiment, the shapes of the flange and the mating female slots can be varied from canister to canister (poka-yoke method).

The autonomous dispensing assembly 400 can also be coupled to a digital portal. The digital portal can be an interface that correlates ingredients within the canister to each canister's location/position on the base platform. The digital portal can also include other information such as canister filling/restocking date and time to enable updating of ingredients. The digital portal can also provide notifications when an ingredient is below a threshold quantity. Furthermore, the digital portal can receive input from a plurality of sensors to process the data and provide accurate and/or real-time updates. The sensors can include, but are not limited to: temperature sensors, humidity sensors, ingredient stock sensors, weight sensors, ultrasonic sensors (placed at a height above the canister to indicate ingredient quantities), visual sensors, infrared sensors, etc. Data from these sensors can be stored on a database, either locally or via cloud-based storage.

Each motor, scoop and canister can have a unique identifier. For example, rice can correspond to canister 1, chicken can correspond to canister 2, lettuce can correspond to canister 3, etc. Furthermore, the mount location of each canister can also have a unique identifier, which can be linked to the unique identifier of the canister. This allows the portal to provide administrative control to ensure the correct canister is installed in the correct position on the base platform. Once an order is received, a processor can parse the order, and actuate only the canisters that have been requested by the user to dispense into the bowl.

As shown from the top view of the autonomous dispensing assembly 400 in FIG. 6B, it can be seen that a plurality of scoop mechanism assemblies can be mounted to base platform 628 and their respective canisters 602 can be mounted to the canister mount top plate 632 and the canister mount bottom plate 634. In one embodiment, the plurality of the scoop mechanism assemblies 600 can be placed equidistantly apart, such that the distance between each of the scoop mechanism assemblies is equal. This can help avoid collision between scoops as they simultaneously move forward and back. The scoop mechanism assembly can be mounted to the base platform between the outer edge of the platform, and the dispensing aperture 652, with the scoop 608 facing, or proximal to the dispensing aperture.

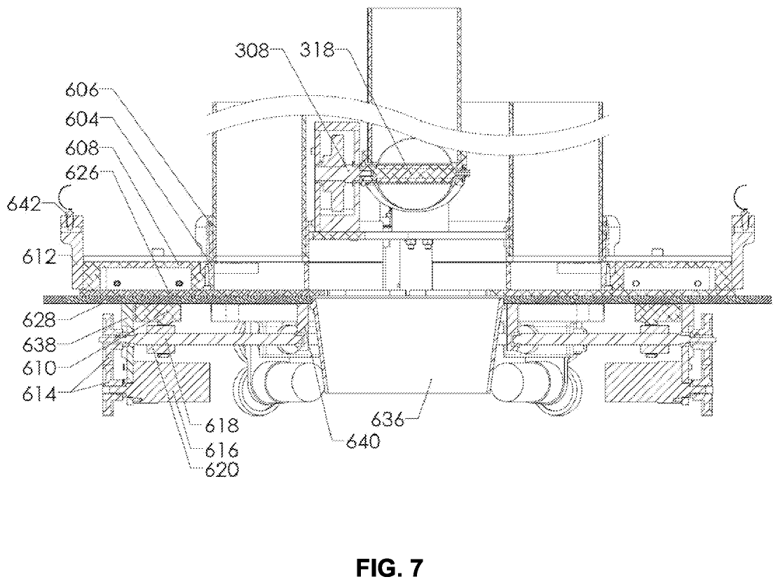

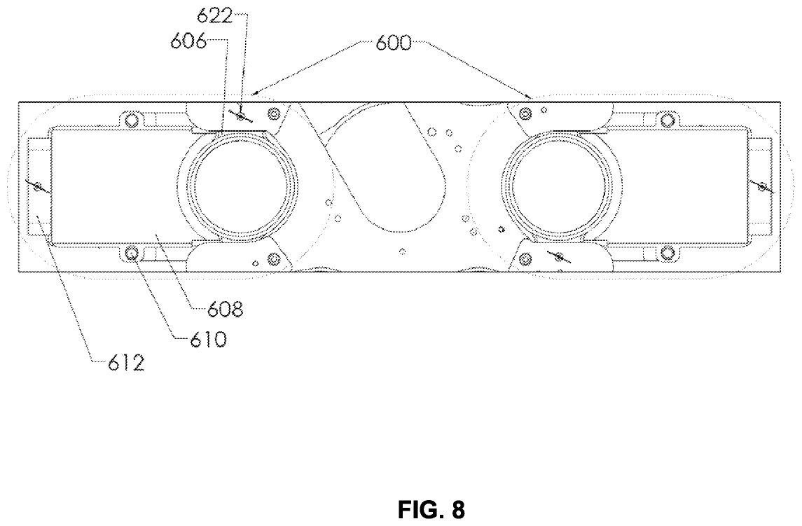

Referring to FIG. 7, the motor 616 can actuate the scoop-pusher 610 which couples with the scoop 608 to move forward for transferring only the food within the scoop 608 from the canister 602 to the food bowl through the dispensing aperture. The motor 616 can be located below the platform in one embodiment. In an alternative embodiment, the motor can be located above the base platform, or beside the base platform. The motor 616 can also be replaced with a pneumatic piston or another kind of linear actuator, to actuate the scoop-pusher forward. A trough or funnel 636 can be located at the dispensing aperture to funnel the ingredients into the food bowl and avoid spillage. The blocking plate 626 is placed between the scoop 608 and the circular base platform 628 to prevent the ingredients from contacting the base platform 628. Below the circular base platform 628, the motor 616 with transmission gears 614 is attached with a suitable bearing mount (not shown) at the transmission gears 614 side. A lead screw 618 is coupled between bearing mount 638 at the transmission gears 614 side and bearing mount 640 at the bowl side. A linear guide rail (not shown) is mounted parallel to the lead screw 618 onto the circular base platform 628, on which a linear carriage and pusher are connected. A scoop mechanism lead nut 620 is rigidly mounted to the scoop-pusher 610 and slide-ably connected along the lead screw 618 so that the scoop-pusher 610 and scoop 608 move together along the linear guide rail (not shown) when the motor 616 is actuated. Thereby, the ingredients in the canister are carried by scoop 608 and dropped into the food bowl. In another aspect, the linear guide rails (not shown) can be removed or replaced with ball transfers, rollers, or wheels mounted between the scoop pusher 610 and the circular base platform 628, such that they can roll or simply slide against the bottom of the circular base platform 628. In an embodiment, the scoop profile is also used such that the scoop 608 has an external profile that is larger than the internal profile of the canister 602 thereby preventing food spillage from the canister 602. In an embodiment, the canister 602 can be of any varying or fixed cross-sectional shape, including square, circular or oval. For example, an oval shaped canister can provide the advantage of ease of cleaning, as well as larger ingredient storage capacity. In one aspect, the bowl size can determine the aperture size, canister size, scoop size, and system size. For example, for small bowls, the system can be sized down by a factor. In contrast, for large bowls, the system can be sized up by a factor. In another aspect, the autonomous dispensing assembly 400 could be arranged linearly instead of the circular arrangement as depicted in FIGS. 5, 7a, 7b, 9 & 18. For example, FIG. 8 provides a top-down view of the scoop mechanism assembly 600 in a linear configuration. In the embodiment shown in FIG. 8, the two scoops face one another. In another embodiment, all scoop mechanism assemblies could be facing in the same direction. In the embodiment where all the scoop mechanism assemblies face the same direction, the dispensing aperture can be a long slot such as a rectangle with rounded edges. In this aspect, the bowl can be stopped under each scoop mechanism assembly to be filled. In another aspect, the scoop mechanism assembly 600 can be actuated with a rotating nut instead of a rotating screw. In further aspects, other types of linear actuators, such as, for example, hydraulic, pneumatic, or other ready-to-use linear actuators, can be used.

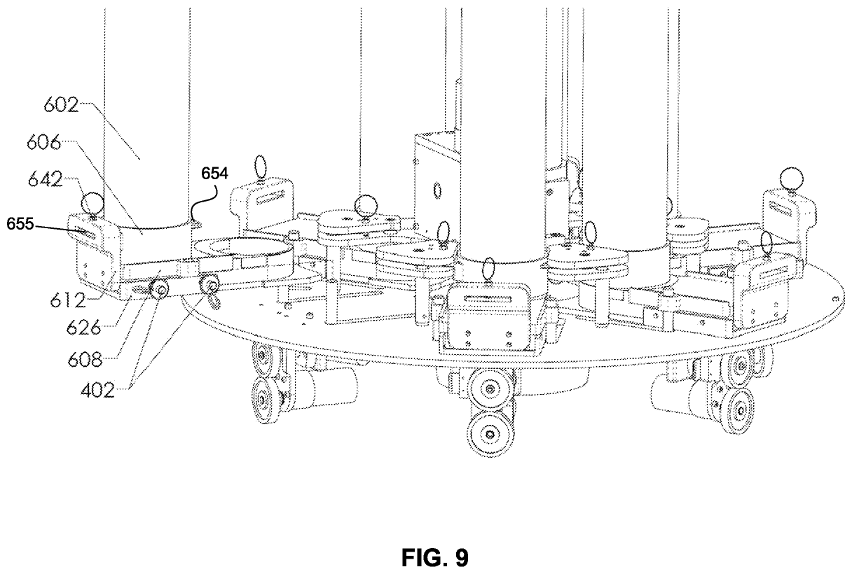

Referring to FIG. 9, which provides a more detailed illustration showing the scoop mechanism assembly 600 being removed from the autonomous dispensing assembly 400. The canister sleeve 606 can be coupled with the scoop 608 via the spring-loaded pull pin 642 located on the canister disassembly mount 612. Furthermore, the scoop 608 is coupled to the blocking plate 626 using pins 402 and sliding them through holes provided on the side of the scoop 608 and blocking plate 626. In other embodiments, bolts, rods or other attaching means can be used as alternatives to the pins 402. This allows the canister sleeve 606; scoop 608 and blocking plate 626 to all be coupled to one another to remove all components exposed to food with ease, quickly, and with minimal spillage whether or not the scoop 608, and the canister 602 were to hold un-dispensed ingredients. This also enables the canister to act as a container even in transportation.

In one embodiment, the volume of the hole in scoop 608 is directly proportional to the volume of the ingredients transferred from the canister 602 to the bowl. In other aspects, the stroke of the scoop is directly proportional to the volume of the food transferred, referred to as ‘fractional dispensing’. In another aspect, referring to FIG. 9 the distance between the maximum forward position of the scoop 608 to the starting point of the forward movement of the scoop 608 (stroke) is directly proportional to the quantity of the food. Therefore, the scoop mechanism 600 allows for dispensing controlled quantities of contained ingredients (metered dispensing).

The parts that come in contact with food or the bowls (including the mechanical components of the bowl denester assembly), in one embodiment, materials that are corrosion-resistant to prevent food contamination and allow for cleaning the parts with water and cleaning agents can be used.

### Paddle Mechanism Assembly

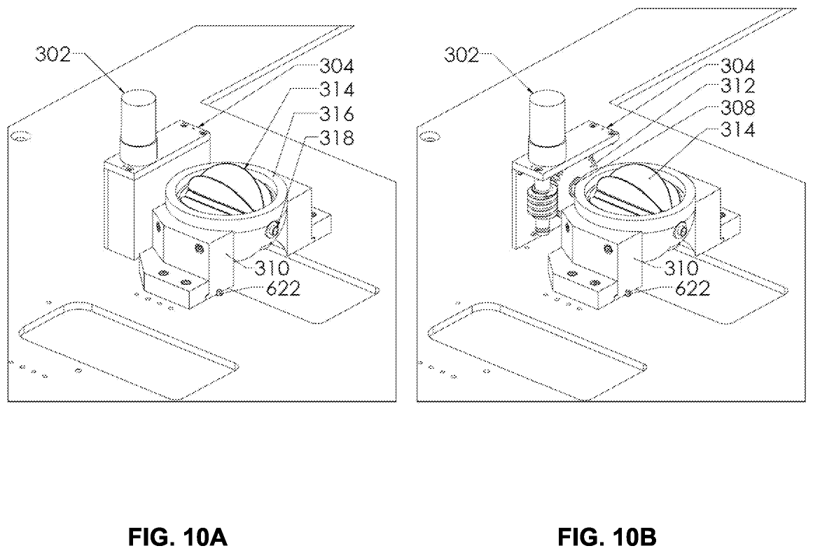

Turning now to FIGS. 10A and 10B, the paddle mechanism assembly 300 is provided therein. The paddle mechanism assembly 300 comprises of a canister which stores the food (not shown); a paddle mechanism motor 302 coupled to a worm-gear transmission that includes a worm gear shaft 308; a gearbox housing 304; a canister mount 310; a worm gear 312; a food dispensing paddle 314; a paddle housing 316 and a paddle shaft 318. Rotating the food dispensing paddle 314 by the paddle mechanism motor 302 allows stored food in the canister to be dispensed into the bowl. After dispensing, the food in the other vanes of the paddle 314 can cause a weight imbalance resulting in torque to unintentionally rotate the paddle. The motor 302 drives the worm-gear transmission, while the worm gear shaft 308 is mated with the paddle shaft 318 which actuates the food dispensing paddle 314, thereby preventing back driving of the paddle. Therefore, the weight imbalance is resisted. In an embodiment, the motor 302 is used to drive the worm gear 312 mechanisms to turn the food dispensing paddle 314. In another embodiment, the worm-gear transmission could be replaced by a back-driveable transmission, wherein the paddle shaft 318 mates with its output shaft.

The ingredients within the canister (not shown) separate into sections between the vanes of the paddle 314 as they come in contact with the food. The rotation of the paddle 314 allows the metered dispensing of the contained ingredients into the food bowl underneath it.

In another aspect, the paddle mechanism assembly 300 is detachably constructed such that the paddle mechanism assembly 300 as depicted in FIGS. 1, 2, 10A, 10B, 7a, and 7b can be slide-ably removed for cleaning. The worm gear shaft 308 removable slides into and mates with paddle shaft 318 which enables easy disassembly from 300 or 400. The canister 602, canister sleeve 606, scoop 608, and blocking plate 626 are removably attached to the autonomous dispensing assembly 400 and the system 100, for cleaning and maintenance.

In an embodiment, the spring-loaded pull pin 622 is used in the paddle mechanism assembly 300 where the spring-loaded pull pin 622 fixes the paddle mechanism assembly 300 such that it may be used as a stopper or retaining feature.

The paddle mechanism assembly 300 is actuated by the worm gear 312, which is driven by the worm. The motor actuates a worm which actuates a worm gear which is coupled with an output shaft which is removably coupled with the paddle inside the canister. A set of dowel pins are locating features (not shown) are used to locate the bottom lid onto the canister mount top plate 632. The paddle mechanism assembly 300 is designed such that it can be securely mounted and easily detached from the autonomous dispensing assembly 400. In an embodiment, the spring-loaded pull pin 622 is used in the paddle mechanism assembly 300 where the spring-loaded pull pin 622 fixes the paddle mechanism assembly 300 such that it may be used as a stopper.

The compactness of the paddle mechanism assembly 300 clubbed with its capability of dispensing directly underneath itself, allows for the effective utilization of valuable real estate in the center of the autonomous dispensing assembly 400 which would otherwise be wasted. This is another embodiment, where the autonomous dispensing assembly 400 proves to have a high ratio of total number of dispensers to the total volume of the assembly.

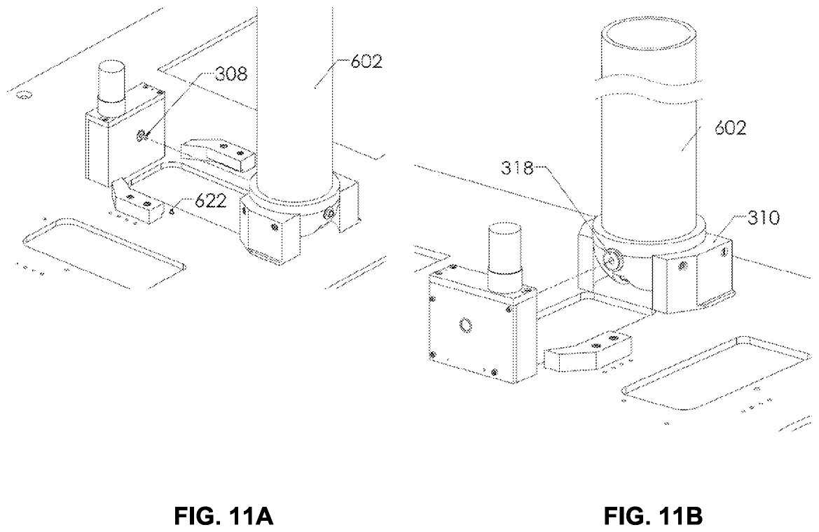

FIGS. 11A and 11B depict the paddle mechanism assembly 300 in a detached position. The paddle shaft 318 couples with the worm gear shaft 308. The paddle mechanism assembly 300, is designed such that it can be securely mounted and easily detachable.

### Heating Assembly

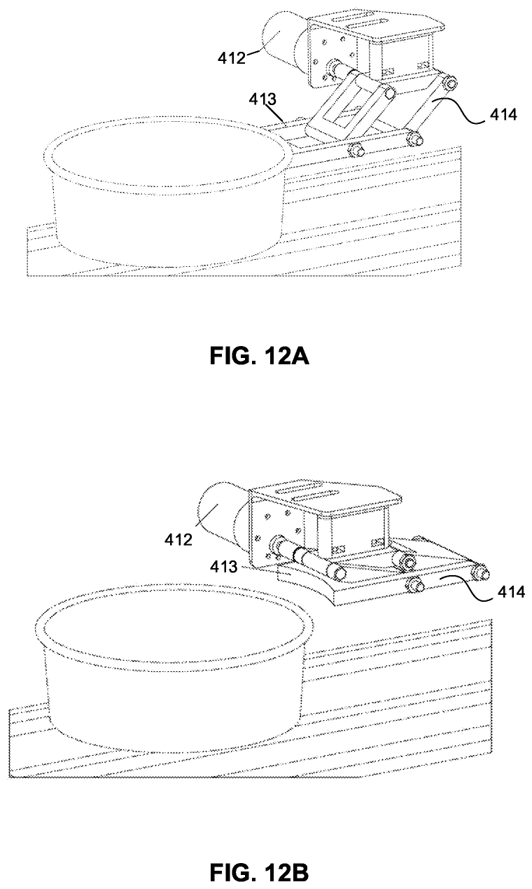

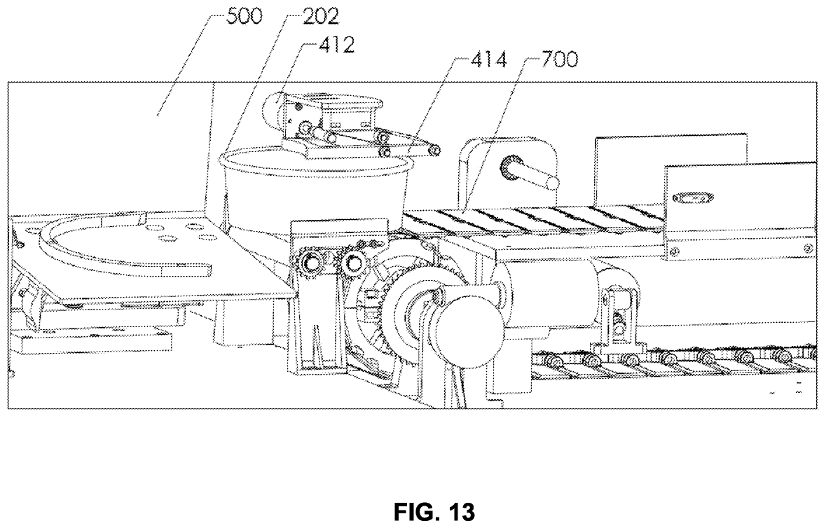

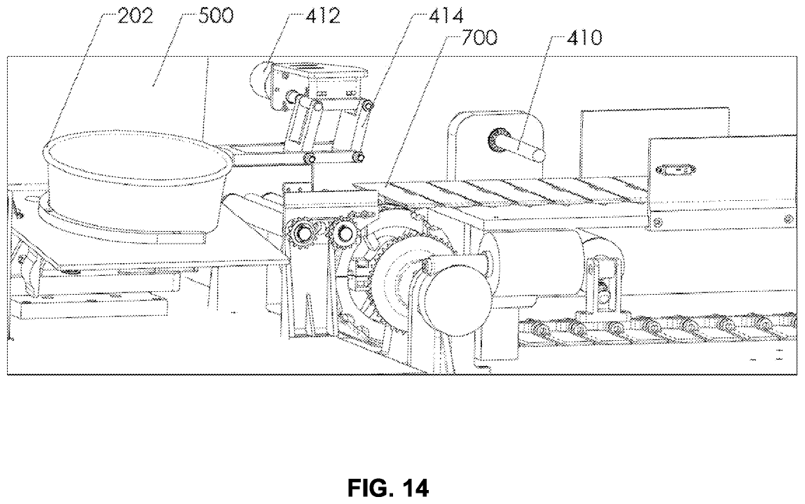

Once the bowl is filled, the bowl can be optionally heated via the heating assembly. The heating assembly 500 receives the food bowl 202 with food, heats the food, and delivers or serves the food bowl 202. The heating assembly 500 can receive the filled food bowl 202 by a bowl-pushing arm 413 comprising a kinematic link 414 and a rotary actuator or motor 412. The bowl-pushing arm 413 is provided in FIGS. 12A and 12B. The bowl-pushing arm 413 is used to transfer the food bowl 202 from the conveyor 700 to the heating assembly 500 and accurately position it on the moving platform. The kinematic link 414 collapses (see FIG. 12B and FIG. 13) to allow the food bowl 202 to pass below it until the food bowl 202 reaches a position where it can extend and push the food bowl 202 onto the heating assembly 500 as depicted in FIG. 14. In an alternative embodiment, the kinematic link can be on the side, perpendicular to the bowl when extended such that the bowl does not have to pass underneath the link, but rather can pass beside the link 414. As shown in FIG. 14, a stopper 410 can be provided which can hold the food bowl 202 until the heating assembly 500 is in a position to receive the food bowl 202 for heating and serving.

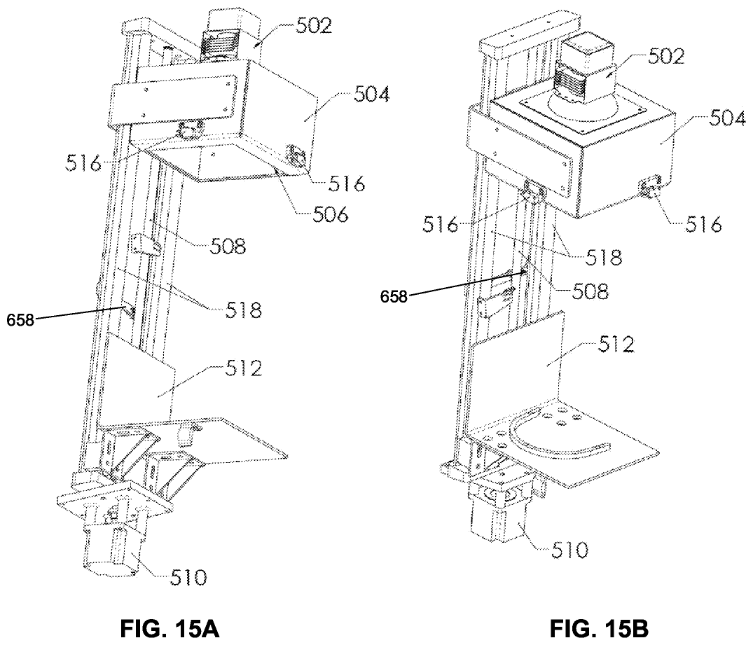

Referring to FIGS. 15-17, in an embodiment, the heating assembly 500 comprises of a magnetron 502 to generate microwaves as a heating device; a heating chamber/microwave chamber 504 with a single opening 506; a serving lead screw 508; a serving lead screw motor 510 and a moving platform 512. In an embodiment, a magnetron can be placed between two assemblies as well. In this embodiment, the bowl can remain stationary while the magnetron heats the bowl on the conveyor. In an embodiment, the heating chamber/microwave chamber 504 has an opening 506 at its base. The food bowl 202 is received by the moving platform 512 from the conveyor 700 at the lowest level. In an embodiment, the moving platform 512 acts like an elevator that travels up and down to various levels as the serving lead screw 508 drives the moving platform 512 along the linear guide rails 518. The moving platform 512 and/or heating chamber/microwave chamber 504 has a microwave sealing component that mates around the opening 506 of the heating chamber/microwave chamber 504. In one embodiment, a microwave shield can be provided on the interior faces of the machine guarding to behave like a Faraday cage as a fail-safe to provide additional safety. When the food bowl needs to be heated, the moving platform 512 travels from the conveyor 700 (located at the lowest level) upwards to the heating chamber/microwave chamber 504 (located at the highest level) and presses up against the opening 506 of the heating chamber/microwave chamber 504 to form a seal and prevent microwaves from escaping.

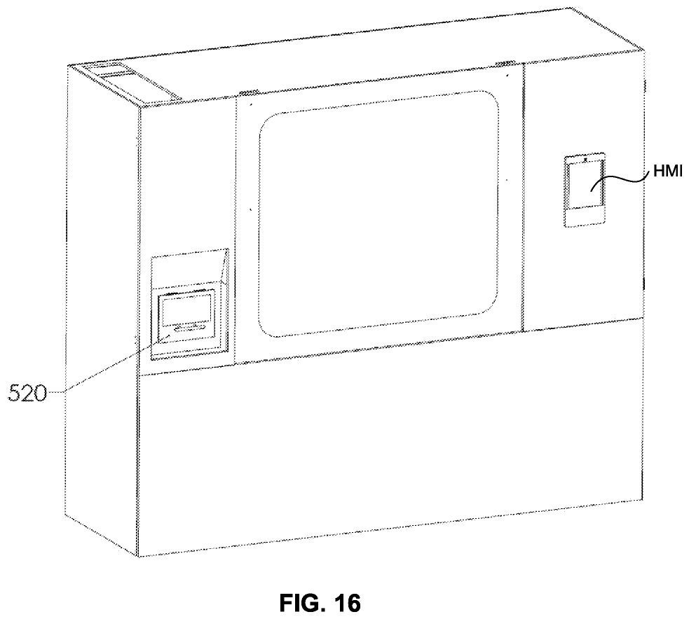

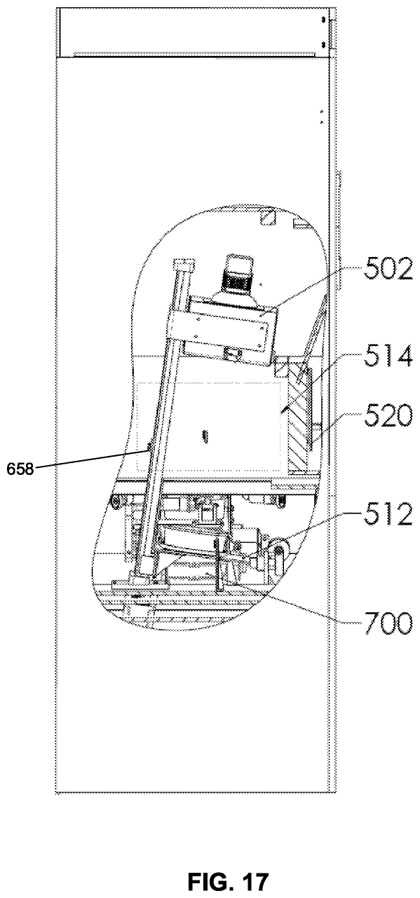

In an embodiment, at least one safety limit switch 516 located on the heating chamber/microwave chamber 504 can be triggered when the moving platform 512 is engaged with the heating chamber/microwave chamber 504. Alternatively, two or more safety limit switches 516 can be used. When the safety limit switches 516 are connected (i.e. when the platform is properly engaged with the microwave chamber), electrical power passes to the magnetron 502 and heat the food bowl 202. If the platform is not properly engaged with the microwave chamber, the safety limit switch(es) will not allow electrical power to pass through and the microwave will not turn on. Once the food bowl 202 is appropriately heated, the moving platform 512 is then lowered to a serving area 514. In an embodiment, the platform can be coupled to the magnetron to form a moving heating/microwave chamber. In an embodiment, the magnetron can be coupled to the heating/microwave chamber. In this embodiment, the chamber can heat the food at any level, and serve at any stage. In an embodiment, the serving area 514 is located at a middle position between the conveyor 700 and the heating chamber/microwave chamber 504 and behind a serving door 520 as depicted in FIGS. 16 and 17. In an alternative embodiment, the platform can travel sideways or downwards towards the heating chamber. In an embodiment, the heating chamber/microwave chamber 504 is statically fixed. This may have the advantage of reducing the number of faces in the microwave chamber 504 that require sealing. In an embodiment, an air fryer/convection oven/toaster-convection oven could be used instead of a microwave.

In another embodiment, the serving area 514 is located at the same level as the heating chamber/microwave chamber 504 (highest level). In this embodiment, the heating chamber/microwave chamber 504 has two openings-one opening at the base (the same as the single opening 506) and another opening where the serving door 520 would interface and seal against to provide customers access to retrieve their food bowls. This may have the advantage of reducing food preparation time as the maximum stroke (from bottommost to topmost levels) and the total number of levels that the moving platform 512 needs to travel could be reduced.

In an embodiment, once the bowl 202 reaches the moving platform 512, or is in a position sufficiently ahead of the kinematic link 414 for it to safely make contact and avoid bowl damage or food spillage, the kinematic link 414 is triggered to thoroughly push the bowl onto the platform and simultaneously positions the bowl onto the moving platform 512 by pushing the bowl 202 against a jigging/locating end stop fixed to the moving platform 512. Once the bowl is positioned accurately (centered) on the moving platform 512 by the kinematic link 414, the serving lead screw motor 510 then drives to raise the platform 512 upwards to the topmost position, where the platform seals against the bottom of the statically fixed heating chamber/microwave chamber 504 where the heat source/magnetron heats the food bowl with dispensed food. Once the bowl is heated in the heating chamber/microwave chamber 504 for a specified duration, the platform lead screw mechanism then actuates again bringing the platform 512 to the middle position and positioning it level with the serving area 514. The serving door 520 is then unlocked and a message prompts the customer to pick up their food bowl 202 from the platform 512. In one embodiment, the serving area 514 can include a door that is locked for all the duration the heating assembly is operating, and unlocks when the bowl is ready to serve and the platform has brought it to the appropriate serving level. In the meantime, more bowls can be prepared and lined up such that they are ready at their respective stops to be loaded onto the serving/microwave platform. A bowl presence sensor 658 at the serving stage checks the presence of a bowl, if the bowl is detected to be successfully removed and is not present on the moving platform 512 once the serving door 520 is detected to be closed again, the platform proceeds to go back to the conveyor 700 at the bottom position to receive the next bowl and the process repeats. If the sensor at the serving level detects a bowl for a fixed duration of time, the customer would be prompted to remove the bowl from the microwave/serving platform so that the following orders are not held up perpetually. Once all the orders are fulfilled, the conveyor 700 can be switched off or temporarily paused.

In an embodiment, the autonomous food preparation system 100 includes a bowl lid closing mechanism, which closes and seals the bowl 202 with a lid and is located before the bowl-pushing arm 413 and the heating assembly 500. The bowl-pushing arm 413 pushes the sealed or closed bowl onto the heating assembly 500. Alternatively, a heat-sealing film mechanism could also be used to close or seal the food within the food bowl 202. A storage zone can also be provided for orders that are ready for pick up. The storage zone can optionally be heated. In an alternative embodiment, the bowl can be prepared and stored until the pickup time, and heated once the customer is proximal to the food preparation system.

### Homing Sequence

In an embodiment, when the food preparation system needs to be turned on, is restocked, or restarted, the system can perform a homing or calibration sequence. All of the assemblies or sub-assemblies can be homed or calibrated. During the homing sequence, the scoop-pushers 610 are pulled back until the scoop-pushers 610 are butting up against the transmission side bearing mount 638 to ensure that no scoop 608 is partially forward. In this position, the motor 616 encoder values are then set as a reference to gauge how far the scoop 608 needs to travel forward. Similarly, the kinematic link 414 is retracted (i.e. collapsed) and homed. Similarly, the stoppers are pushed closed during the homing process. The moving platform is also brought to the conveyor level if there is no bowl present on it.

In an embodiment, the moving platform 512 is also brought to the bottommost position until it triggers a limit switch when the moving platform 512 is at the conveyor level. In an embodiment, the position of the moving platform 512 is detected by using an absolute encoder. The stoppers 410 are all ensured to be closed (such that they obstruct the bowl travel path on the conveyor).

### Collision Avoidance

When a plurality of canisters are present within the autonomous dispensing assembly 400, it can be time consuming to actuate each scoop-pusher independently to dispense ingredients one by one. In one embodiment, the autonomous dispensing assembly can dispense one ingredient at a time, by actuating one scoop at a time. In an alternative embodiment, the autonomous dispensing assembly 400 parallelizes serving such that while one or many scoops return after dispensing an ingredient, another set of scoop(s) can simultaneously be driven forward to dispense the next ingredient.

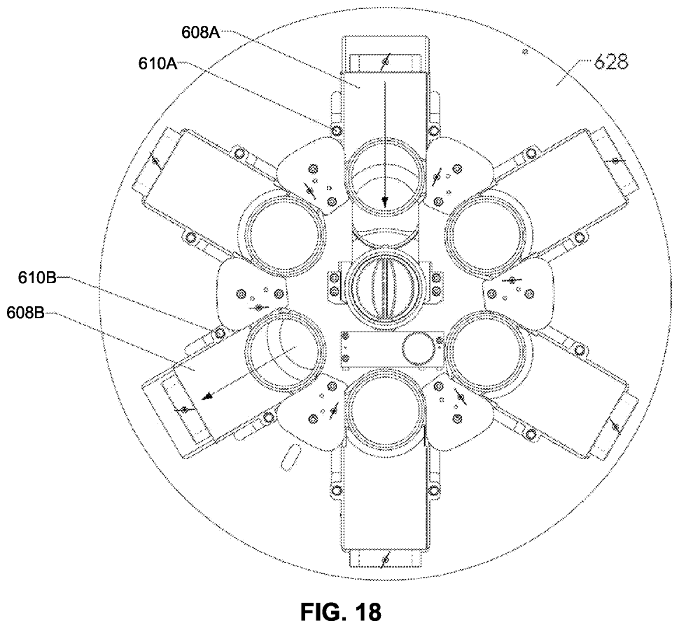

One can optimize the time needed to add ingredients by timing the actuation of the scoop-pusher 610 such that while one or more scoop(s) 608 and its/their respective scoop-pusher(s) 610 return to the rest position after having dropped food into the bowl, another set of scoop(s) 608 and scoop-pusher(s) 610 can simultaneously be traveling forward to the dispensing aperture to dispense its ingredient(s). Therefore, the autonomous dispensing assembly 400 can save time by parallelizing the dispensing of ingredients and rapidly filling the bowl. The controller algorithm is set up so that the least amount of time is used to serve all the necessary ingredients by grouping the maximum number of scoop(s) that can be actuated forward with the maximum number of scoop(s) that can be actuated in reverse, and maximizing the number of such groups. FIG. 18 illustrates one scoop 608B and its scoop pusher 610B returning (away from the dispensing aperture of the circular base platform 628) after dispensing its ingredient, while another scoop 608A and its scoop pusher 610A is simultaneously moving forward (toward the dispensing aperture of the circular base platform 628) to dispense its ingredients. In another embodiment, multiple scoops 608 and their respective scoop pushers 610 could be returning after dispensing their ingredients while multiple scoops 608 and their respective scoop pushers 610 simultaneously move forward to serve their ingredients.

However, this can result in potential collisions at, or near the dispensing aperture, particularly in the case where one scoop moves forward while another directly adjacent scoop moves backward simultaneously. As such, a collision avoidance algorithm and method was developed to avoid the potential collisions between at least two adjacent scoops.

In the case that there are N scoops, arranged circularly, and equidistantly spaced apart on the base platform 628, the potentially colliding scoops can be located at +/−X canisters away from N, where X is the number of scoops that collide, and is inversely proportional to the size of the dispensing aperture. In other words, if the dispensing aperture is sufficiently large, then X can approach 0, and all the scoops can travel simultaneously. On the other hand, if the dispensing aperture is small, then X can be increased. For example, X can be +/−1 scoop adjacent, +/−2 scoops adjacent, +/−3 scoops adjacent, etc. that cannot travel simultaneously when the current scoop, N, is travelling. N can be any natural number, for example, 1, 2, 3, 4, 5, . . . 50, 51, 52, and beyond, etc.

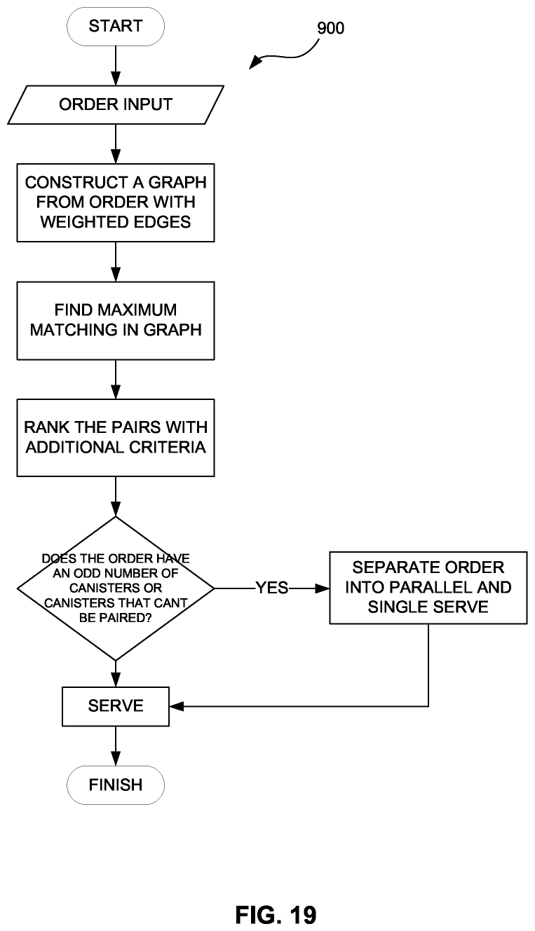

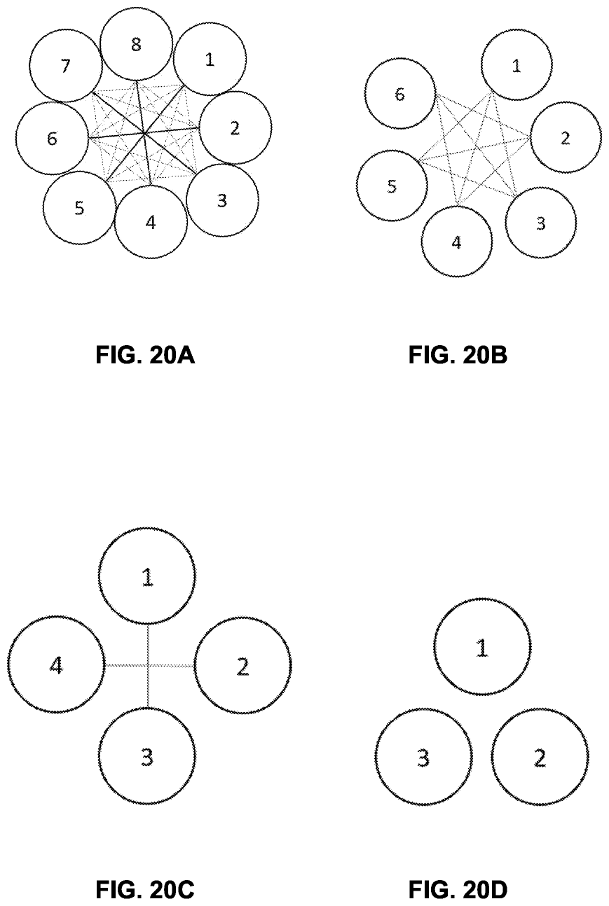

FIG. 19 provides a process flow diagram of the collision avoidance algorithm 900 and corresponding method. The algorithm is used to find a set of edges in a graph such that no two edges share a common vertex, as shown in FIGS. 20A and 20B. In other words, given a graph, the algorithm identifies pairs of vertices connected by a single edge.

The method begins when an order is placed. If a user requests 5 ingredients in the food bowl, each of the canisters to be dispensed is marked as ‘active’. The ingredients that are not part of the user's recipe can be ignored for the current order. Each of the corresponding active scoops can be represented as a node, and a graph can be constructed by connecting various scoops, as shown in FIG. 20A, 20B 20C. Since adjacent scoops (by +/−X scoops) cannot move simultaneously, this constraint is incorporated into the graph's structure.

Each canister can be connected to any other canister, except for adjacent ones. A connection between two canisters implies that they can be served together. Based on these connections, our goal is to find a set of edges where no vertices are shared (see FIG. 20D), meaning that when selecting pairs of canisters to serve, no canister is used more than once.

For example, in the scenario depicted in FIG. 20B, canister 1 can be connected to canisters 3, 4, and 5. However, the serve sequence (1,3), (1,4), (1,5) would be incorrect, as canister 1 is used multiple times, even though all ingredients are served. Instead, a correct serve sequence would be (1,4), (2,5), and (3,6), where each pair represents connected vertices, and no vertex is repeated. This is referred to as maximum matching.

Maximum matching is particularly useful because it functions regardless of the graph's structure. This means that more canisters can be added or additional constraints can be imposed, such as ensuring that no X number of canister adjacent to a given node is served simultaneously, and the algorithm will still operate effectively. This flexibility allows the autonomous dispensing assembly to be expanded to hold up to hundreds of canisters, while maintaining a robust and efficient serving process.

Additionally, the matching algorithm serves as a foundation for incorporating more complex criteria, such as the order of serving. In the current example, all edges in the graph have equal weight, meaning that selecting (1,3) is as valid as selecting (1,4). However, if canisters 1 and 3 both contain rice while canister 4 contains lettuce, we might want the algorithm to prioritize serving (1,4) over (1,3) based on ingredient type.

As such, instead of excluding certain canisters from being served together, weights can be assigned to the edges, allowing the algorithm to prioritize specific pairings. In this case, the weight of the edge between (1,4) would be higher than that between (1,3), encouraging the algorithm to choose the more relevant pairing. Thus, the graph would be modified to incorporate these weighted edges for prioritized serving.

This approach assists in determining which canisters should be prioritized when forming pairs within an order. By assigning weights to the edges based on criteria such as ingredient type or importance, the algorithm selects the most relevant pairings. After the pairs are formed, they can be further ranked using different ranking strategies, depending on additional factors like the sequence of serving, time constraints, or customer preferences.

Since the autonomous food preparation system can cater to a diverse range of customers, each with unique requirements and constraints on how their orders should be served, the proposed method offers the necessary flexibility to accommodate these variations. By using the maximum matching algorithm, the autonomous dispensing assembly can be limit adapted to different serving conditions—including prioritizing certain canisters, adhering to specific constraints, or introducing new canisters. This ensured that the serving process remains both efficient and customizable for each customer's needs.

### Advantages

The various embodiments disclosed herein may have various advantages for restaurants or other food service providers, such as, for example: accurately portion and serve ingredients to their end customer without human error. The system also eliminates any source of cross-contamination and possible allergic ingredients for end users. The system further allows the serving of two different ingredients almost simultaneously (parallel serving where one scoop is retracting and the other is progressing to serve). The system can also store food ingredients at refrigerated temperatures to avoid spoilage. The system can also sense chamber temperatures for detailed monitoring and troubleshooting. The system can also serve both hot and cold meals to the end customers. The system can also serve many kinds of foods, allowing for many permutations and combinations of the ingredients in the canisters. The food preparation system can store food ingredients at refrigerated temperatures, to minimize spoilage. The food preparation system can also track the quantity of each ingredient to ensure timely re-ordering and food safety. In an alternative embodiment, the food preparation system can limit the offerings to only available ingredients to customers.

Each canister can also be used as a container which can be carried back and forth between restaurants for reloading food. The scoop's flat-top section acts as a bottom lid for the canister in the “stow/transport” configuration. The simple shape of the canisters can allow for the canisters to be easily cleaned by hand or in a dishwasher. Brushes can be used to clean the canisters. An oval shaped canister can also be used to allow a hand to fit inside for cleaning.

The system can also have a storefront presence in expensive or remote areas and therefore increase overall revenue as the apparatus can serve as an autonomous kitchen located in a cluster, within a serviceable radius, around a restaurant or commissary kitchen, both indoors and outdoors. The system can also track the quantity of each ingredient and be notified if an ingredient is low or below a set level so that the service provider is warned before the ingredient empties. The system can also recognize the last stock date and prevent the sale of expired or old ingredients more easily making managing food easier.

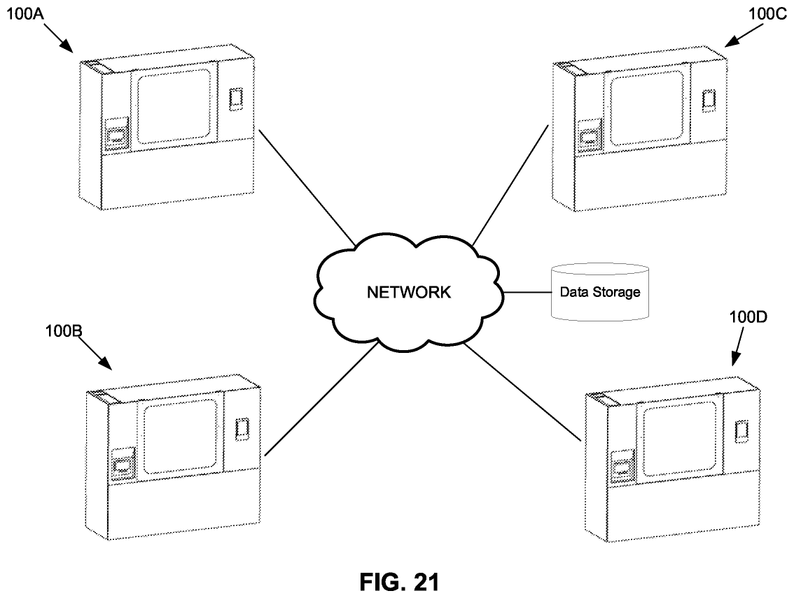

The system can also feature a kiosk-based model, as shown in FIG. 21. Here, a number of food preparation systems are provided, that each transmit data to a common cloud-based server over a network. Each autonomous food preparation system 100A, 100D, 100C, and 100D can then be monitored and gather data on how much of which ingredient is being sold and at what time, at which kiosk, so that the service provider can act on demand and more closely cater to their user's preferences.

The kiosks are also easy to relocate as the kiosks are portable. In some embodiments, the kiosks can include wheels so that they can be easily moved from one location to the next. In one embodiment, the wheels may include brakes and locks to ensure the wheels do not travel when the kiosk is in position. In one embodiment, the kiosk may weigh around 100 kg to around 500 kg. In one embodiment, the kiosk can be pushed on wheels with two people. In another embodiment, the kiosk may have a forklift profile so that it can be lifted and transported by a forklift. In one embodiment, the kiosk may include a plurality of jack points for lifting the machine up, adding wheels for transportation, and then removing wheels once the kiosk is in the final location.

In some embodiments, the kiosks can be around 7 feet high by 3 feet wide, by 7 feet long. For example, the kiosk may be sized to fit through a doorway. In some embodiments, such as for commercial uses, the kiosks can be larger. In some embodiments, the kiosks do not require disassembly. Owners can also provide service to the kiosks with no requirements from site infrastructure such as water supply or plumbing. The system can operate by using a small number of breakers, either a 110V or 220V standard electrical power, and therefore does not require any electrical wiring from the existing infrastructure. The system allows restaurant owners to increase sales by pricing meals more competitively, improve quality of ingredients, and/or increase margins as the system can reduce operating costs.

The various embodiments disclosed herein may also have various advantages for end users/customers, such as, for example: the ability to pick up hot bowl orders within 1-3 minutes of placing an order at more convenient locations that traditional brick-and-mortar stores cannot be put up or are too expensive to setup and maintain; the ability to purchase food 24×7 as it is entirely autonomous (unmanned). This can be especially crucial at round-the-clock locations such as airports, and hospitals. Furthermore, the system avoids human contact to maintain complete hygiene as there is no human intervention once the ingredients are stocked. The customers can accurately personalize bowls i.e. by choosing which ingredients they want and how much of each ingredient including sauces and garnishes, or pick from a pre-set menu item. The users can also place orders on mobile phone applications, or by using the HMI, reducing queues and improving wait times as customers can place order on route to the kiosk.

### Clauses

In one clause, an autonomous food preparation system, apparatus and/or system apparatus (referred to below as the ‘system’) is disclosed. The system comprises: a bowl denester assembly in which a stack of bowls is arranged, a pair of paddle mechanism assemblies, a pair of multi-food ingredients dispensing assemblies comprising of scoop mechanism assemblies, and a heating assembly. In the system of any of the above clauses, the pair of paddle mechanism assemblies are connected in sequence to the bowl denester assembly.

In the system of any of the above clauses, a conveyor with a motor operable drive is connected below the paddle mechanism assembly and scoop mechanism assembly. In the system of any of the above clauses, the paddle mechanism assembly comprises a canister; a position-controlled or timed motor; and a food dispensing paddle. In the system of any of the above clauses, the food dispensing paddle is rotated by the position-controlled or timed motor which allows stored food in the canister to be dispensed into the bowl. In the system of any of the above clauses, the bowl moves on the conveyor from the paddle mechanism assembly to the autonomous dispensing assembly. In the system of any of the above clauses, each of the scoop mechanism assemblies comprising the canister; a canister sleeve, a scoop, a scoop-pusher, a canister disassembly mount, and a position-controller or timed motor. In the system of any of the above clauses, the scoop assembly is removably attachable to a circular base platform, below which the motor actuates the scoop-pusher or the scoop to move forward for transferring the food from the canister to the bowl. In the system of any of the above clauses, the bowl reaches a position where a stop rod (also referred to as stopper) stops the bowl to fill the food ingredients dispensed.

In the system of any of the above clauses, the heating unit comprises of: a heating source magnetron; a statically fixed microwave chamber with a single opening at its base; and a moving platform. In the system of any of the above clauses, the bowl is received by the moving platform from the conveyor. In the system of any of the above clauses, the moving platform has a microwave sealing component that mates around the opening of the microwave chamber. In the system of any of the above clauses, once the bowl is heated, the moving platform is lowered to a serving area which is located between the conveyor and the microwave chamber.

In the system of any of the above clauses, the serving area is unlocked and a message prompts the customer to pick up their bowl. In the system of any of the above clauses, the apparatus receives input from a Human Machine Interface (HMI) or user's mobile app or delivery app consisting of a list of foods or processed foods in an electronic form displayed to the user to select a food or food mixture. In the system of any of the above clauses, the bowl denester assembly comprises of: a position-controlled or timed motor, at least three belt pulleys, and a belt or chain. In the system of any of the above clauses, the three belt pulleys are connected with the belt or chain. In the system of any of the above clauses, when any one of the pulleys is actuated by the position-controlled or timed motor, the bottom-most bowl makes contact with a worm screw thereby detaching the bowl and dropping it on the conveyor.

In the system of any of the above clauses, the autonomous dispensing assembly includes the paddle mechanism assembly or scoop mechanism assembly or a combination of both. In the system of any of the above clauses, the position-controlled or timed motor of the paddle mechanism assembly is coupled with a worm gear shaft that actuates the paddle thereby preventing back driving of the paddle. In the system of any of the above clauses, rotation of the paddle, allows for dispensing controlled quantities of contained ingredients (metered dispensing) into the food bowl. In the system of any of the above clauses, the canister disassembly mount couples the canister, scoop, and a bottom lid and is detachably connected. In the system of any of the above clauses, the scoop-pusher and scoop move together towards the trough or bowl when the motor is actuated, and thereby the food in the canister is carried by the scoop and dropped to the bowl. In the system of any of the above clauses, the bottom lid is placed between the scoop and the circular base platform which protects the food from contacting said base platform.

In the system of any of the above clauses, the autonomous food preparation system apparatus optimizes the time needed to add food ingredients by timing the actuation of the scoop-pusher such that while one or more of scoop and scoop-pusher pair is returning after having dropping food into the food bowl, another scoop(s) and their respective scoop-pusher(s) simultaneously/synchronously travels forward to drop its ingredient thereby saving time by parallelizing the dispensing of ingredients and rapidly filling the food bowl.

In the system of any of the above clauses, the stop rod is actuated by a linear actuator to stop the food bowl until the subsequent station is in a position to receive and service the food bowl. In the system of any of the above clauses, the paddle mechanism assembly and scoop mechanism assembly are detachably constructed such that the paddle mechanism assembly is slide-ably removed. In the system of any of the above clauses, the canister and bottom lid are remove-ably detached from the scoop mechanism assembly. In the system of any of the above clauses, the scoop is remove-ably detached from the scoop-pusher. In the system of any of the above clauses, the heating unit receives the food bowl where a bowl-pushing arm comprising of: a kinematic link and an actuator is used to transfer the food bowl from the conveyor to the heating unit. In the system of any of the above clauses, the kinematic link retracts to allow the bowl to pass underneath, or beside it and move to a position where it can extend to push the food bowl to the heating assembly. The kinematic link can be on the side such that the bowl does not have to pass underneath, but rather on the side.

In another clause, an autonomous food preparation system is provided. In the system of any of the above clauses, the autonomous food preparation system comprises: at least one autonomous dispensing assembly. The at least one autonomous dispensing assembly having: at least one canister containing ingredients to be dispensed; at least one attachment member coupled to each of the at least one canisters; a base platform having a dispensing aperture and at least one canister mount for each of the at least one canisters, the base platform in a fixed position; the attachment member coupling the canister to the canister mount; and at least one scoop mechanism assembly mounted on the base platform, around the outer edge of the dispensing aperture. In the system of any of the above clauses, the scoop mechanism assembly comprises: a scoop-pusher slidably mounted to the base platform, the scoop-pusher removably engaging a scoop for holding a metered amount of ingredients; and the scoop having a blade edge interacting with the bottom opening of each of the at least one canisters to cut the metered amount of ingredients into the scoop. In the system of any of the above clauses, the scoop mechanism assembly further comprises a blocking plate for blocking a bottom opening of the at least one scoop.

In the system of any of the above clauses, the at least one autonomous dispensing assembly further comprises an actuator for actuating the scoop-pusher from a first position up to a second position, the second position located above the dispensing aperture.

In the system of any of the above clauses, the scoop-pusher dispenses a metered amount of ingredients into the dispensing aperture by horizontally translating the ingredients away from the canister towards a dispensing location above the dispensing aperture.

In the system of any of the above clauses, a bowl can be positioned under the aperture for receiving the ingredients dispensed during a dispensing period. In the system of any of the above clauses, during the dispensing period, the scoop-pusher moves from the first position into the second position, and the relative position of the at least one canister, the bowl, and the aperture are stationary during the dispensing period.

In the system of any of the above clauses, the autonomous food preparation system further comprises at least one channel located on the base platform for guiding a post on the scoop mechanism assembly between the first position to the second position.

In the system of any of the above clauses, the autonomous food preparation system further comprises a conveyor coupled to the base platform to move the bowl from a first location to a second location below the dispensing aperture; the conveyor having a motor-operable driver, and a bowl guide rail to guide the bowl between the first and second locations.

In the system of any of the above clauses, the autonomous food preparation system further comprises a canister disassembly mount detachably coupling the at least one canister to the scoop.

In the system of any of the above clauses, the scoop-pusher and scoop move together towards the dispensing aperture when the motor is actuated to dispense the metered amount of ingredients into the aperture by horizontal translation of the ingredients away from the canister.

In the system of any of the above clauses, the blocking plate can be placed between the scoop and the base platform to protect the ingredients in the canister from contacting the base platform.

In the system of any of the above clauses, the canister and blocking plate are removably detached from the base platform during transportation of the canister.

In the system of any of the above clauses, the autonomous food preparation system further comprises at least two canisters, each having a scoop mechanism assembly connected thereto. In the system of any of the above clauses, the autonomous food preparation system optimizes the time needed to add ingredients by actuating the first scoop-pusher such that while the scoop and scoop-pusher of the first canister begins returning to the first position, a scoop and scoop-pusher of the second canister simultaneously travels up to the second position to drop the ingredients into the bowl.

In the system of any of the above clauses, the autonomous food preparation system further comprises a stopper for stopping the bowl when the bowl reaches a position below the dispensing aperture to fill the food ingredients dispensed.

In the system of any of the above clauses, the stopper can be actuated by a linear actuator to stop the bowl below the dispensing aperture.

In the system of any of the above clauses, the autonomous food preparation system further comprises a Human Machine Interface (HMI) coupled to the autonomous food preparation system for placing an order; the HMI comprising a list of foods; and causing the autonomous dispensing assembly to start the dispensing period by actuating the scoop pusher to dispense the metered amount of ingredients into the bowl. In the system of any of the above clauses, the autonomous food preparation system may additionally or alternatively comprise a camera system to scan a QR code for placing an order, and causing the autonomous dispensing assembly to start the dispensing period by actuating the scoop pusher to dispense the metered amount of ingredients into the bowl.

In the system of any of the above clauses, the autonomous food preparation system further comprises a paddle mechanism assembly coupled to an inner chute of the at least one canister of the autonomous dispensing assembly. In the system of any of the above clauses, the paddle mechanism assembly comprises a motor; and a food dispensing paddle. In the system of any of the above clauses, the food dispensing paddle can be located within the canister. In the system of any of the above clauses, the food dispensing paddle can be rotated by the motor which allows stored food in the at least one canister to be dispensed into the bowl.

In the system of any of the above clauses, the paddle mechanism assembly can be located above the dispensing aperture.

In the system of any of the above clauses, the paddle mechanism assembly further comprises a worm gear shaft coupled to the motor, the worm gear shaft actuating the paddle and preventing back driving of the paddle.

In the system of any of the above clauses, wherein the motor comprises a time-controlled motor which rotates the paddle for a given amount of time, or a position-controlled motor which rotates the paddle for a number of rotations, or a given angle of rotation.

In the system of any of the above clauses, the autonomous food preparation system further comprises a bowl denester assembly for denesting a plurality of bowls which are stacked.

In the system of any of the above clauses, the bowl denester assembly comprises: a worm screw; a belt, a position-controlled motor; and a plurality of belt pulleys connected to the belt. In the system of any of the above clauses, when at least one of the pulleys are actuated by the position-controlled motor, an upper ridge of the bowl from the stack of bowls makes contact with the worm screw, thereby detaching the bowl and dropping the bowl on the conveyor.

In the system of any of the above clauses, an autonomous food preparation system comprising a heating assembly is provided. In the system of any of the above clauses, the heating assembly comprises a bowl heating unit having a heating source magnetron; a microwave chamber having an opening at its base; and a vertically-movable lower platform which couples to the microwave chamber by coupling to the opening at the base of the microwave chamber. In the system of any of the above clauses, the heating assembly can be located downstream of the at least one autonomous dispensing assembly.

In the system of any of the above clauses, the moving platform has a microwave sealing component that mates around the opening at the base of the microwave chamber and/or the moving platform. In the system of any of the above clauses, the sealing component be the housing of the autonomous food preparation system itself.

In the system of any of the above clauses, the microwave chamber receives the bowl by raising the vertically-movable platform from the conveyor; and once the bowl is heated, the vertically-movable platform can be lowered to a serving area.

In the system of any of the above clauses, the bowl heating unit receives the bowl. In the system of any of the above clauses, a bowl-pushing arm having a kinematic link and an actuator transfers the bowl from the conveyor to the heating and serving unit.

In the system of any of the above clauses, the kinematic link retracts to allow the bowl to move to a position where it can extend to push the bowl to the food heating unit.

In the system of any of the above clauses, the autonomous food preparation system further comprises a serving area for presenting a prepared bowl.

In yet another clause, a method of autonomously dispensing ingredients into a bowl using an autonomous dispensing system is provided herein. In the method of any of the above clauses, the method comprises: mounting at least one a scoop mechanism assembly to a base platform having a dispensing aperture of the autonomous dispensing system; coupling at least one canister to each of the scoop mechanism assemblies; providing a scoop-pusher slidably mounted to the base platform, the scoop-pusher removably engaging a scoop for holding a metered amount of ingredients; the scoop having a blade edge interacting with the bottom opening of each of the at least one canisters to cut the metered amount of ingredients into the scoop; blocking a bottom opening of the at least one scoop with a blocking plate; actuating the scoop pusher, by an actuator, to dispense a metered amount of ingredients into the aperture by horizontal translation of the ingredients away from canister location to a dispensing location above the dispensing aperture; and positioning a bowl under the aperture for receiving the ingredients dispensed. In one the method of any of the above clauses, a relative position of the at least one canister, the bowl, and the aperture are stationary.

In the method of any of the above clauses, the method further comprises sliding a post on the actuator through at least one channel located on the base platform to move the scoop mechanism assembly between the first position to the second position.

In the method of any of the above clauses, the method further comprises coupling a conveyor to the base platform to move the bowl from a first location to a second location below the dispensing aperture; the conveyor having a motor-operable driver, and a bowl guide rail to guide the bowl between the first and second locations.

In the method of any of the above clauses, the method further comprises detachably engaging a canister disassembly mount to the at least one canister to disassemble the canister.

In the method of any of the above clauses, the method further comprises placing the blocking plate between the scoop and the base platform to protect the ingredients in the scoop from contacting the base platform.

In the method of any of the above clauses, the canister and blocking plate are removably detached from the base platform during transportation of the canister.

In the method of any of the above clauses, the autonomous dispensing system can comprise at least two canisters, each having a scoop mechanism assembly connected thereto. In the method of any of the above clauses, the method further comprises optimizing the time needed to add ingredients by actuating the first scoop-pusher such that while the scoop and scoop-pusher of the first canister begins returning to the first position, a scoop and scoop-pusher of the second canister simultaneously travels up to the second position to drop the ingredients into the bowl.

In the method of any of the above clauses, the method further comprises stopping the bowl, via a stopper, when the bowl reaches a position below the dispensing aperture to fill the food ingredients dispensed.

In the method of any of the above clauses, the method further comprises actuating the stopper by a linear actuator to stop the bowl below the dispensing aperture.

In the method of any of the above clauses, the method further comprises coupling a Human Machine Interface (HMI) to the food preparation system for placing an order; the HMI comprising a list of foods; and causing the autonomous dispensing assembly to start the dispensing period by actuating the scoop pusher to dispense the metered amount of ingredients into the bowl.

In the method of any of the above clauses, the method further comprises: coupling a paddle mechanism assembly to an inner chute of the at least one canister of the autonomous dispensing assembly.

In the method of any of the above clauses, the paddle mechanism assembly can comprise: a motor; and a food dispensing paddle; wherein the food dispensing paddle is located within the canister. In the method of any of the above clauses, the method further comprises rotating the food dispensing paddle by the motor which allows stored food in the at least one canister to be dispensed into the bowl.

In the method of any of the above clauses, the paddle mechanism assembly is located above the dispensing aperture.

In the method of any of the above clauses, the paddle mechanism assembly further comprises a worm gear shaft coupled to the motor, and the method further comprises actuating the worm gear shaft and the paddle to prevent back driving of the paddle.

In the method of any of the above clauses, the method further comprises actuating a time-controlled motor to rotate the paddle for a given amount of time, or actuating a position-controlled motor to rotate the paddle for a number of rotations, or a given angle of rotation.

In the method of any of the above clauses, the method further comprises denesting the bowl from a stack of bowls using a bowl denester assembly.

In the method of any of the above clauses, the bowl denester assembly can comprise: a worm screw; a timing belt, a position-controlled motor; and a plurality of belt pulleys connected to the belt. In the method of any of the above clauses, when at least one of the pulleys is actuated by the position-controlled motor, an upper ridge of the bowl from the stack of bowls makes contact with the worm screw, thereby detaching the bowl and dropping it on the conveyor.

In the method of any of the above clauses, the method further comprises heating the bowl via a heating assembly. In the method of any of the above clauses, the heating assembly can comprise: a bowl heating unit having a heating source magnetron; a microwave chamber having an opening at its base; and a vertically-movable lower platform which couples to the microwave chamber by coupling to the opening at the base of the microwave chamber.

In the method of any of the above clauses, the moving platform has a microwave sealing component that mates around the opening at the base of the microwave chamber and/or the moving platform.

In the method of any of the above clauses, the microwave chamber receives the bowl by raising the vertically-movable platform from the conveyor; and once the bowl is heated, the vertically-movable platform is lowered to a serving area.

In the method of any of the above clauses, the bowl heating unit receives the bowl; and wherein a bowl-pushing arm having a kinematic link and an actuator transfers the bowl from the conveyor to the heating and serving unit.

In the method of any of the above clauses, the kinematic link retracts to allow the bowl to move to a position where it can extend to push the bowl to the food heating unit.

In the method of any of the above clauses, the method further comprises presenting a prepared bowl at a serving area.

In another clause, a method of optimizing the dispensing of food ingredients in a plurality of canisters using an autonomous dispensing assembly is provided herein. In the method of any of the above clauses, the method comprises: determining two or more of the plurality of canisters to be actuated simultaneously; and parallelizing serving by actuating the determined at least two of the plurality of canisters to dispense ingredients.

In the method of any of the above clauses, determining two of more of the plurality of canisters comprises: inputting an order; marking a number of canisters that correspond to the order as active canisters; representing the active canisters as a plurality of nodes; constructing a graph from the plurality of nodes, and ignoring adjacent nodes from the graph; and determining, by maximum matching, pairs of edges where none of the plurality of nodes are shared.

In the method of any of the above clauses, the method further comprises: assigning weights to the pairs of edges to prioritize specific pairs of edges corresponding to prioritized canisters.

In the method of any of the above clauses, the method further comprises: ranking the assigned weighting based on at least one of the following factors: sequence of serving, time constraints, or customer preferences.

In the method of any of the above clauses, parallelizing serving by actuating the determined at least two of the plurality of canisters to dispense ingredients further comprises: actuating at least two scoop mechanism assemblies connected to the at least two canisters, such that while a scoop and scoop-pusher of the first canister begins returning to a first position, a scoop and scoop-pusher of the second canister simultaneously travels up to a second position to dispense the ingredients.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures, and components have not been described in detail so as not to obscure the description of the embodiments. Furthermore, this description is not to be considered as limiting the scope of these embodiments in any way, but rather as merely describing the implementation of these various embodiments.

Parts list is as follows:

| | Part |
|---|---|
| Description | number |
| Autonomous food preparation system apparatus | 100 |
| bowl denester assembly | 200 |
| bowls | 202 |
| denester motor | 204 |
| top plate | 206 |
| belt pulleys | 208 |
| bottom plate | 210 |
| belt or chain | 212 |
| worm screw | 214 |
| tensioning bolt | 216 |
| Tensioning pulley | 218 |
| tensioning pulley shaft | 220 |
| paddle mechanism assembly | 300 |
| position-controlled or timed motor | 302 |
| gearbox housing | 304 |
| worm gear shaft | 308 |
| canister mount | 310 |
| worm gear | 312 |
| food dispensing paddle | 314 |
| paddle housing | 316 |
| paddle shaft | 318 |
| autonomous dispensing assembly | 400 |
| pin | 402 |
| bowl guide rail | 404 |
| a set of trip sensors | 406 |
| linear actuator | 408 |
| Stopper | 410 |
| Rotary Actuator/Motor | 412 |
| Bowl-pushing arm | 413 |
| Kinematic link | 414 |
| microwave heating assembly | 500 |
| heating source/magnetron | 502 |
| heating chamber/microwave chamber | 504 |
| single opening | 506 |
| serving lead screw | 508 |
| serving lead screw motor | 510 |
| moving platform | 512 |
| Serving area | 514 |
| safety limit switches | 516 |
| linear guide rails | 518 |
| Serving door | 520 |
| Scoop mechanism | 600 |
| canister | 602 |
| knife | 604 |
| canister sleeve | 606 |
| scoop | 608 |
| scoop-pusher | 610 |
| Scoop main body | 611 |
| canister disassembly mount | 612 |
| transmission gears | 614 |
| motor | 616 |
| lead screw | 618 |
| scoop mechanism lead nut | 620 |
| spring-loaded pull pin | 622 |
| distance sensor | 624 |
| Blocking Plate/Scoop Tray | 626 |
| circular base platform | 628 |
| spacer ring | 630 |
| canister mount | 631 |
| canister mount top plate | 632 |
| canister mount bottom plate | 634 |
| Trough/Funnel | 636 |
| Transmission side bearing mount | 638 |
| Bowl side bearing mount | 640 |
| spring loaded pull pin | 642 |
| Back of scoop | 644 |
| Flanges | 646 |
| Posts | 648 |
| Slots | 650 |
| dispensing aperture | 652 |
| Winged Attachment Members | 654a, 654b |
| Slot | 656 |
| Bowl Presence Sensor | 658 |
| conveyor | 700 |
| collision avoidance algorithm | 900 |

What is claimed is:

1. An autonomous food preparation system, comprising:
at least one autonomous dispensing assembly comprising:
at least two canisters containing ingredients to be dispensed;
at least two attachment members, wherein each attachment member is coupled to a corresponding canister;
a base platform comprising a dispensing aperture, the base platform further comprising at least one canister mount for a corresponding canister, the base platform being in a fixed position, wherein the canister mount is coupled to the corresponding canister via the corresponding attachment member;
each canister being coupled to a corresponding scoop mechanism assembly and a corresponding actuator, the corresponding scoop mechanism assembly being mounted on the base platform around the outer edge of the dispensing aperture, and wherein each scoop mechanism assembly comprises:
a scoop-pusher slidably mounted to the base platform, the scoop-pusher removably engaging a scoop for holding a metered amount of ingredients; and
the scoop having a blade edge interacting with the bottom opening of the corresponding canister to cut the metered amount of ingredients into the scoop; and
a blocking plate for blocking a bottom opening of the scoop;
the corresponding actuator being configured to actuate the corresponding scoop-pusher from a corresponding first position to a second position, the second position located above the dispensing aperture, and
the scoop-pusher dispensing a metered amount of ingredients into the dispensing aperture by horizontally translating the ingredients away from the corresponding canister towards a dispensing location above the dispensing aperture;
wherein a bowl is positioned under the dispensing aperture for receiving the ingredients dispensed during a dispensing period; and
wherein the corresponding position of each of the at least two canisters, the bowl, and the dispensing aperture is fixed during the dispensing period;
a controller coupled to each actuator, wherein the controller parallelizes the dispensing by actuating a first scoop-pusher corresponding to a first canister and a second scoop-pusher corresponding to a second canister, such that while the first scoop and the first scoop-pusher corresponding to the first canister begins returning to the corresponding first position, a second scoop and the second scoop-pusher of the corresponding second canister simultaneously travels to the second position to drop the ingredients into the bowl; and
wherein the controller is configured to control one or more actuators to avoid collision of one or more scoops, and the control of the one or more actuators being determined based on one or more factors.

2. The autonomous food preparation system of claim 1, wherein at least one factor of the one or more factors is: selection of a canister, controlling a time of actuation of a canister, sequence of actuation of a scoop-pusher corresponding to a canister.

3. The autonomous food preparation system of claim 1, further comprising at least one channel located on the base platform for guiding a post on each scoop mechanism assembly between the first position to the second position.

4. The autonomous food preparation system of claim 1, further comprising a conveyor coupled to the base platform to move the bowl from a first location to a second location below the dispensing aperture; the conveyor having a motor-operable driver, and a bowl guide rail to guide the bowl between the first and second locations.

5. The autonomous food preparation system of claim 1, wherein each scoop mechanism assembly further comprises a canister disassembly mount detachably coupling the corresponding canister to the corresponding scoop.

6. The autonomous food preparation system of claim 1, wherein each blocking plate is placed between the corresponding scoop and the base platform to protect the ingredients in the corresponding canister from contacting the base platform.

7. The autonomous food preparation system of claim 1, wherein each canister and corresponding blocking plate are removably detached from the base platform during transportation of the canister.

8. The autonomous food preparation system of claim 1, further comprising a stopper for stopping the bowl when the bowl reaches a position below the dispensing aperture to fill the food ingredients dispensed.

9. The autonomous food preparation system of claim 8, wherein the stopper is actuated by a linear actuator to stop the bowl below the dispensing aperture.

10. The autonomous food preparation system of claim 1, further comprising a heating assembly, the heating assembly comprising:
a bowl heating unit having a heating source magnetron;
a microwave chamber having an opening at its base; and
a vertically-movable lower platform which couples to the microwave chamber by coupling to the opening at the base of the microwave chamber.

11. The autonomous food preparation system of claim 10, wherein the moving platform comprises a microwave sealing component that mates around the opening at the base of the microwave chamber and/or the moving platform.

12. The autonomous food preparation system of claim 11, wherein the microwave chamber receives the bowl by raising the vertically-movable platform from the conveyor; and once the bowl is heated, the vertically-movable platform is lowered to a serving area.

13. A method of autonomously dispensing ingredients into a bowl using an autonomous dispensing system,
the autonomous dispensing system comprising at least one autonomous dispensing assembly comprising a base platform, the base platform comprising a dispensing aperture;
the method comprising:
mounting at least two scoop mechanism assemblies to the base platform around the outer edge of the dispensing aperture;
coupling at least two canisters containing ingredients to be dispensed to a corresponding scoop mechanism assembly via a corresponding attachment member;
for each of the at least two scoop mechanism assemblies, providing a scoop-pusher slidably mounted to the base platform, the scoop-pusher removably engaging a scoop for holding a metered amount of ingredients; the scoop having a blade edge interacting with the bottom opening of the corresponding canister to cut the metered amount of ingredients into the corresponding scoop;
blocking a bottom opening of the scoop with a blocking plate;
actuating the scoop pusher, by a corresponding actuator, to dispense a metered amount of ingredients into the dispensing aperture by horizontal translation of the ingredients away from a corresponding canister location to a dispensing location above the dispensing aperture;
positioning a bowl under the dispensing aperture for receiving the ingredients dispensed; wherein a corresponding position of each of the at least two canisters, the bowl, and the dispensing aperture is fixed during the dispensing period; and
parallelizing, by a controller coupled to the actuator, the dispensing by actuating a first scoop-pusher corresponding to a first canister and a second scoop-pusher corresponding to a second canister, such that while the first scoop and the first scoop-pusher corresponding to the first canister begins returning to the corresponding first position, a second scoop and the second scoop-pusher of the corresponding second canister simultaneously travels to the second position to drop the ingredients into the bowl;
wherein the controller is configured to control one or more actuators to avoid collision of one or more scoops, and the control of the one or more actuators being determined based on one or more factors.

14. The method of claim 13, further comprising sliding a post on the actuator through at least one channel located on the base platform to move the scoop mechanism assembly between the first position to the second position.

15. The method of claim 13, further comprising coupling a conveyor to the base platform to move the bowl from a first location to a second location below the dispensing aperture; the conveyor having a motor-operable driver, and a bowl guide rail to guide the bowl between the first and second locations.

16. The method of claim 13, further comprising detachably engaging a canister disassembly mount to each of the at least two canisters to disassemble the canister.

17. The method of claim 13, further comprising placing the blocking plate between the scoop and the base platform to protect the ingredients in the scoop from contacting the base platform.

18. The method of claim 13, wherein the canister and blocking plate are removably detached from the base platform during transportation of the canister.

19. The method of claim 13, further comprising stopping the bowl, via a stopper, when the bowl reaches a position below the dispensing aperture to fill the food ingredients dispensed.

20. The method of claim 13, further comprising assigning a unique identifier to each actuator, each scoop and each canister, and using the unique identifiers by a controller to determine which ingredients are located in each canister.
